(19) United States
(12) Patent Application Publication
(10) Pub. No.: US 2026/0273929 A1
(43) Pub. Date: Sep. 17, 2026

(54) PRINTING APPARATUS AND STORAGE MEDIUM

(71) Applicant: CANON KABUSHIKI KAISHA, Tokyo (JP)

(72) Inventors: YUHEI OIKAWA, Kanagawa (JP); YOSHIAKI MURAYAMA, Tokyo (JP); KAZUKI TAKAHASHI, Tokyo (JP); SHUZO IWANAGA, Kanagawa (JP); YASUHIKO OSAKI, Kanagawa (JP); KOICHI ISHIDA, Tokyo (JP); FUMI TANAKA, Kanagawa (JP)

(21) Appl. No.: 19/404,351

(22) Filed: Dec. 1, 2025

(30) Foreign Application Priority Data
Jan. 20, 2025 (JP) 2025-007678

(51) Int. Cl. B41J 2/045; B41J 3/54

(52) U.S. Cl. CPC B41J 2/04528; B41J 2/04508; B41J 2/04515; B41J 2/0458; B41J 2/04581; B41J 3/543

(57) ABSTRACT

A technology capable of suppressing the occurrence of condensation is to be provided. The present disclosure includes: a printing element substrate configured to eject ink onto a print medium that performs relative movement; an update unit configured to update target temperatures; and a temperature adjustment unit configured to perform temperature adjustment for a plurality of areas in the printing element substrate in accordance with the target temperatures, wherein the plurality of areas includes a first area and a second area that partially overlaps with the first area in a first direction, which is the direction of the relative movement, and that is located on the upstream side relative to the first area, and wherein the update unit updates the target temperatures corresponding to the plurality of areas based on the target temperature corresponding to the printing element substrate and offset temperatures that are set for the plurality of areas.

### BACKGROUND

### Field of the Technology

The present disclosure relates to a printing apparatus and a storage medium.

### Description of the Related Art

In a printing apparatus that performs printing by ejecting ink onto a print medium, energy is generated within each ejection port in a print head, thereby ejecting ink from each ejection port. Systems for generating the energy include a system of pressurizing ink using an electrothermal conversion element such as a piezoelectric element, and a system of heating ink to generate bubbles using an electrothermal conversion element equipped with a heating resistor.

In such a printing apparatus, in a case images (especially high-duty images) are continuously printed, the humidity may increase in the space between a print medium and a surface of a print head in which ejection ports for ejecting ink are formed (the ejection port plane), causing condensation to occur on the ejection port plane. If condensation occurs near the ejection ports, the ink ejection performance from the ejection ports deteriorates, resulting in a decrease in the printing quality. Japanese Patent Laid-Open No. 2005-022160 discloses a technology for suppressing the occurrence of such condensation by heating a print head, using a heating unit.

However, condensation on the ejection port plane selectively occurs depending on a relationship between a temperature distribution on the ejection port plane and an airflow flowing over the surface of the ejection port plane. Therefore, with the technology disclosed in Japanese Patent Laid-Open No. 2005-022160, in which the entire ejection port plane is uniformly heated, it has been sometimes impossible to eliminate a temperature distribution that occurs on the ejection port plane along with printing, and thus the occurrence of condensation cannot be suppressed.

### SUMMARY

The present disclosure has been made in view of the above-described problems, and provides a technology capable of suppressing the occurrence of condensation.

A printing apparatus includes: a printing element substrate configured to eject ink from ejection ports by driving printing elements onto a print medium that performs relative movement; an update unit configured to update target temperatures for temperature adjustment; and a temperature adjustment unit configured to be capable of executing temperature adjustment for a plurality of areas in the printing element substrate in accordance with the target temperatures, wherein the plurality of areas includes a first area and a second area that partially overlaps with the first area in a first direction, which is the direction of the relative movement, and that is located on the upstream side relative to the first area, wherein the update unit updates the target temperatures corresponding to the plurality of areas based on the target temperature corresponding to the printing element substrate and offset temperatures that are set for the plurality of areas, and wherein the offset temperatures for the first area and the second area are set so as to make a temperature of the first area become close to a temperature of the second area.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic configuration diagram of a printing apparatus;

FIG. 2A and FIG. 2B are configuration diagrams of a control system of the printing apparatus;

FIG. 3 is a schematic configuration diagram of the ejection port plane of a print head;

FIG. 4A to FIG. 4C are schematic configuration diagrams of a printing element substrate;

FIG. 5 is a perspective view of a cross section taken along line V-V in FIG. 4A;

FIG. 6A and FIG. 6B are diagrams for describing a configuration relating to temperature control of the printing element substrate;

FIG. 7A and FIG. 7B are diagrams for describing the occurrence of condensation and a concern that may arise from the condensation;

FIG. 8A to FIG. 8C are diagrams for describing the mechanism by which condensation occurs within the printing element substrate;

FIG. 9A and FIG. 9B are diagrams for describing a technology for suppressing condensation from occurring within the printing element substrate;

FIG. 10 is a flowchart illustrating the details of processing of an update process in the first embodiment;

FIG. 11A and FIG. 11B are tables illustrating offset temperatures for the respective temperature control areas;

FIG. 12A to FIG. 12C are diagrams for describing the occurrence and suppression of condensation on adjacent printing element substrates;

FIG. 13 is a flowchart illustrating the details of processing of an update process in the second embodiment;

FIG. 14A and FIG. 14B are diagrams for describing how condensation is suppressed from occurring on adjacent printing element substrates between print heads; and

FIG. 15 is a flowchart illustrating the details of processing of an update process in the third embodiment.

### DESCRIPTION OF THE EMBODIMENTS

Hereinafter, with reference to the accompanying drawings, detailed descriptions are given of examples of an embodiment of a printing apparatus and a storage medium. Note that the following embodiments are not intended to limit the present disclosure, and all combinations of the characteristics described in the present embodiments are not necessarily essential to the solutions provided in the present disclosure. Further, the positions, shapes, etc., of the constituent elements described in the embodiments are merely examples, and are not intended to limit the scope of this disclosure thereto.

### First Embodiment

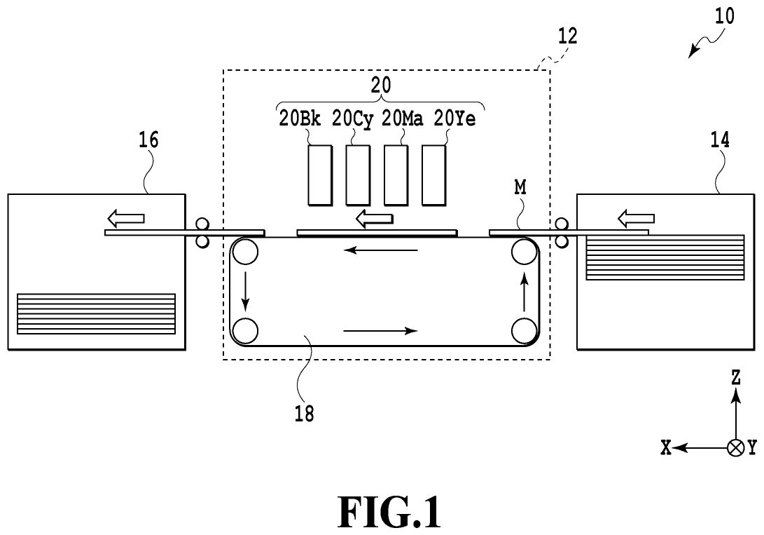

First, with reference to FIG. 1 to FIG. 11B, a detailed description is given about the printing apparatus according to the first embodiment.

### <Configuration of the Printing Apparatus>

FIG. 1 is a schematic configuration diagram of a printing apparatus according to the present embodiment. The printing apparatus 10 in FIG. 1 is a sheet-fed full-line type printing apparatus equipped with print heads, in each of which ejection ports for ejecting ink are arranged into arrays over an area corresponding to the printable widthwise length of the print medium M.

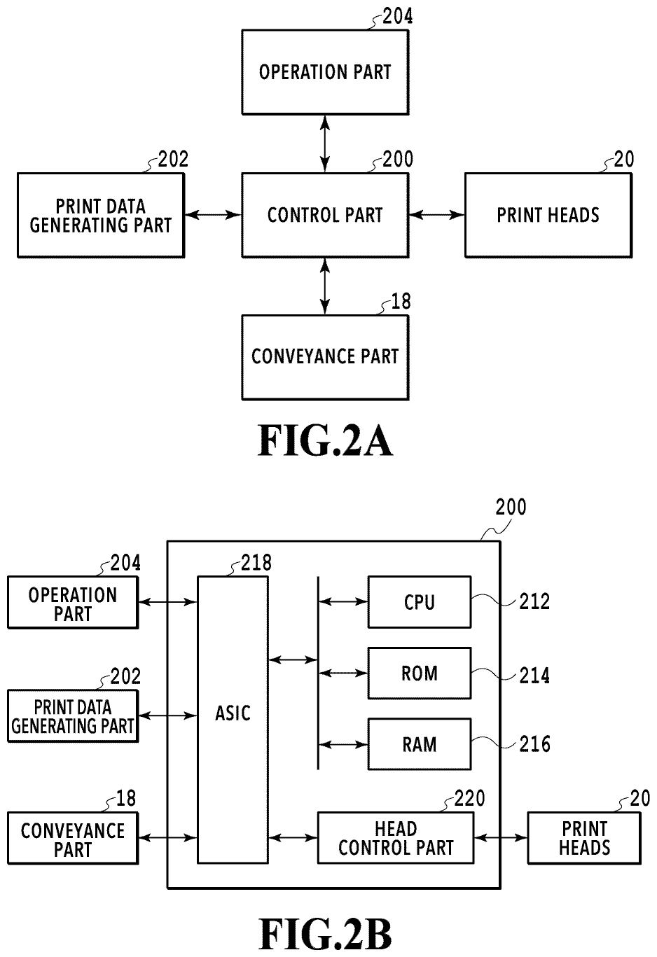

The printing apparatus 10 is equipped with the printing part 12 that performs printing on the print medium M being conveyed, the feeding part 14 that feeds the print medium M to the printing part 12, and the stacking part 16 onto which the print medium M printed in the printing part 12 is discharged and stacked. Note that, between the printing part 12 and the stacking part 16, a configuration that has functions such as drying ink, fixing ink, cooling the print medium M, and reversing the print medium M may be arranged. Further, the printing apparatus 10 is equipped with the control part 200 (see FIG. 2A) that controls the overall operation of the printing apparatus 10.

The printing part 12 is equipped with the conveyance part 18 that conveys the print medium M fed by the feeding part 14, and the print heads 20 that perform printing by ejecting ink onto the print medium M conveyed by the conveyance part 18. In the present embodiment, ink ejected from the print heads 20 is not limited to ink containing coloring materials such as pigments and dyes, but also includes ink that does not contain coloring materials, treatment liquid for performing a predetermined process on the ink ejected onto the print medium M, etc. The conveyance part 18 conveys the print medium M in the X direction. The print heads 20 are configured to be capable of printing in the Y direction within a range corresponding to the printable maximum widthwise (Y direction) length of the print medium M.

### <Configuration of the Control System of the Printing Apparatus>

Next, a description is given about the configuration of the control system of the printing apparatus 10. FIG. 2A and FIG. 2B are diagrams illustrating the configuration of the control system of the printing apparatus 10, where FIG. 2A is a diagram illustrating the configuration centered on the control part in the printing apparatus, and FIG. 2B is a diagram illustrating the configuration of the control part. The printing apparatus 10 is equipped with the control part 200, the print data generating part 202, the operation part 204, the conveyance part 18, and the print heads 20 (see FIG. 2A).

The print data generating part 202 generates print data, which is the data of an image to be printed. The generated print data is output to the control part 200. The print data generating part 202 is not limited to such a form installed in the printing apparatus 10, but may be a form configured by, for example, an external server or external computer connected to the printing apparatus 10.

The operation part 204 receives operations by a user or a service staff, and notifies the user or the service staff of various kinds of information. The operation part 204 may be equipped with, for example, a display part that displays various kinds of information, buttons that can be pressed by the user, etc., or may be a touch panel on which displayed buttons can be selected. Further, the operation part 204 may be a form configured by, for example, an external computer or the like connected to the printing apparatus 10.

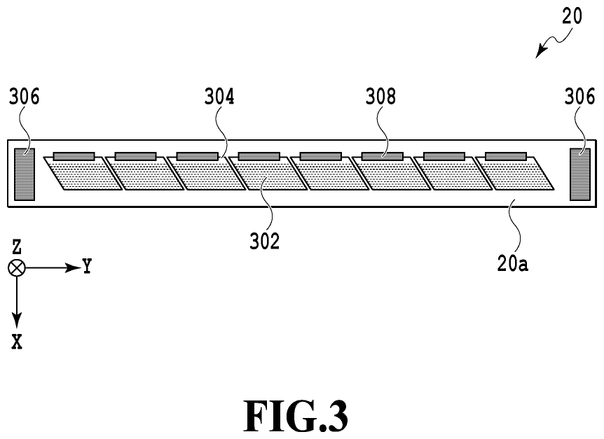

The control part 200 controls the overall operation of the printing apparatus 10, including printing onto the print medium M. The control part 200 includes the CPU 212, the ROM 214, the RAM 216, the ASIC 218, and the head control part 220. The CPU 212 loads various control programs stored in the ROM 214 into the RAM 216 and controls each component of the printing apparatus 10. The ROM 214 stores various kinds of data such as control programs for the CPU 212 and parameters necessary for printing operation. The RAM 216 is used as a work area for the CPU 212 and also temporarily stores various kinds of data. The ASIC 218 is an integrated circuit for specific applications with a built-in network controller, serial interface controller, head data generation controller, motor controller, etc. The head control part 220 generates ejection data to be used by the print heads 20, based on input print data. Further, the head control part 220 generates driving voltages for the printing elements 510 (described later) and sub-heaters 604 (described later) installed on each printing element substrate 304 (see FIG. 3) in the print heads 20.

### <Configuration of the Print Heads>

Next, a description is given about the configuration of the print heads 20. FIG. 3 is a diagram illustrating an ejection port plane of the print heads 20. The print head 20 is a full-line head that extends in the width direction (the Y direction) of the print medium M. On the plane (ejection port plane) 20a of the print head 20 that faces the print medium M being conveyed, multiple printing element substrates 304 each of which has multiple ejection ports 302 formed therein are arranged into an array along the Y direction. In the printing apparatus 10, during printing on the print medium M, the ejection port plane 20a of the print head 20 is fixed with respect to the conveyance part 18 with a minute clearance of about 1 mm from the print medium M being conveyed. Further, in the printing apparatus 10, a plurality of the multiple print heads 20 is arranged along the conveyance direction (the X direction).

In the present embodiment, each print head 20 is configured to eject a different ink (see FIG. 1). The print head 20Ye that ejects yellow (Ye) ink, the print head 20Ma that ejects magenta (Ma) ink, the print head 20Cy that ejects cyan (Cy) ink, and the print head 20Bk that ejects black (Bk) ink are arranged side by side in this order in the +X direction. Note that the colors and the number of inks that can be ejected by the printing apparatus 10 are not limited to the colors and the number of inks described above. The print heads 20 are each connected to an ink tank (not illustrated in the drawings) storing the corresponding ink via a tube (not illustrated in the drawings), so that ink is supplied from the ink tank via the tube.

The ejection port plane 20a of each print head 20 is equipped with the positioning parts 306 for positioning and fixing the print head 20 with respect to the conveyance part 18, near both ends in the Y direction where the printing element substrates 304 are not arranged. The positioning parts 306 are configured so that a corresponding positioning member (not illustrated in the drawings) formed on the conveyance part 18 can be fitted thereto, for example. The positioning member is fitted into the positioning parts 306, thereby defining the distance between the print medium M conveyed by the conveyance part 18 and the ejection port plane 20a of the print head 20. The electrical terminal parts of the printing element substrates 304 are sealed with the sealing agent 308.

Each printing element substrate 304 has a plurality of ejection ports formed into arrays along the Y direction. In the following description, an array formed by the ejection ports 302 so as to extend in the Y direction is referred to as an “ejection port array.” Further, in each printing element substrate 304, a plurality of such ejection port arrays is arranged side by side in the X direction. In the present embodiment, in each printing element substrate 304, one ejection port array is formed by 512 ejection ports 302 arranged into an array with an interval of 600 dpi between adjacent ejection ports 302, and 16 such ejection port arrays are formed. Adjacent ejection port arrays are arranged with a shift of 1200 dpi in the Y direction. Note that the number of ejection ports 302 to form one ejection port array in each printing element substrate 304, the number of ejection port arrays formed in each printing element substrate 304, the interval between adjacent ejection ports 302, the displacement amount of adjacent ejection port arrays in the Y direction, etc., are not limited to the values described above.

As described above, on the ejection port plane 20a, a plurality of the printing element substrates 304 is arranged side by side along the Y direction. As a result, the ejection port arrays formed in the respective printing element substrates 304 are connected, so that a plurality of ejection port arrays extending over substantially the entire area in the extending direction of the ejection port plane 20a is arranged side by side in the X direction. The ejection port arrays extending over substantially the entire extending direction of the ejection port plane 20a extend in the direction (the Y direction) that intersects (orthogonally in the present embodiment) with the conveyance direction of the print medium M (the X direction).

### <Configuration of the Printing Element Substrates>

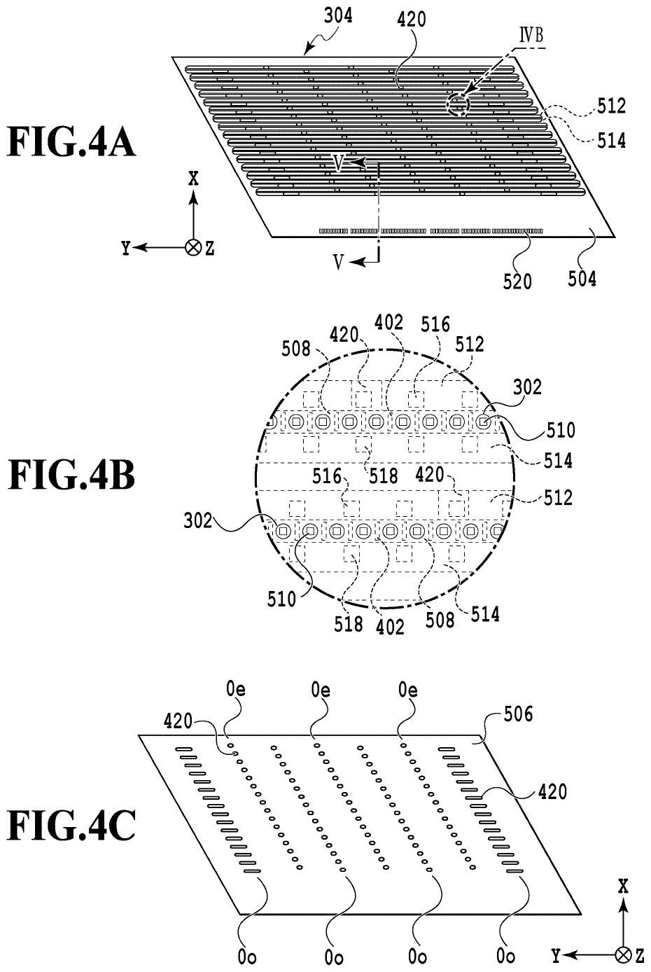

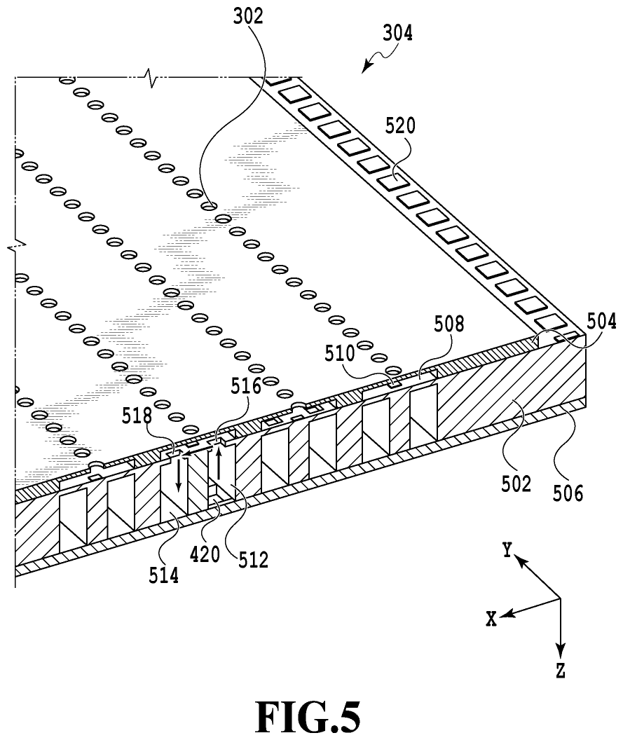

Next, a description is given about the outline of the configuration of the printing element substrates 304. FIG. 4A to FIG. 4C are schematic diagrams of the printing element substrate 304, where FIG. 4A is a diagram seen from the plane on which the ejection ports are formed, FIG. 4B is an enlarged view within frame IVB in FIG. 4A, and FIG. 4C is a diagram illustrating a cover plate. FIG. 5 is a perspective view of the vicinity of a cut part, which is obtained by cutting along line V-V in FIG. 4A. Note that, in FIG. 4A and FIG. 4B, for ease of understanding, the liquid supply paths, the liquid recovery paths, and the openings formed in the printing element substrate 304 are illustrated in a transparent manner. Note that, in the present specification, “temperature adjustment” is also referred to as “temperature control.”

As illustrated in FIG. 5, in the printing element substrate 304, the ejection port forming member 504 in which the ejection ports 302 are formed is installed on one plane of the substrate 502, and the cover plate 506 is bonded to the other plane of the substrate 502. The substrate 502 is made of silicon (Si). The ejection port forming member 504 is formed by laminating a photosensitive resin on one plane of the substrate 502. The ejection port forming member 504 has a plurality of the ejection ports 302 arranged along the Y direction to form ejection port arrays, and a plurality of these ejection port arrays is arranged side by side in the X direction (see FIG. 4B and FIG. 5). In the ejection port forming member 504, the pressure chambers 508 are formed at positions corresponding to the respective ejection ports 302, and each pressure chamber 508 is sectioned by the partition 402 (see FIG. 4B).

In the cover plate 506, opening arrays Oo (described later) and opening arrays Oe (described later), which are arrays of multiple openings 420 arranged at an angle with respect to the X direction, are alternately arranged side by side along the Y direction (see FIG. 4A and FIG. 4C). In adjacent opening arrays, the openings 420 are formed so as to be shifted by a predetermined amount in the X direction. The cover plate 506 preferably has sufficient corrosion resistance against ink, and the openings 420 are required to have a high degree of accuracy in their shapes and positions. Therefore, it is preferable to use a photosensitive resin material or a silicon plate to form the cover plate 506, and to form the openings 420 by a photolithography process.

On one plane of the substrate 502, in each pressure chamber 508, at a position corresponding to each ejection port 302, the printing element 510 capable of generating energy for ejecting ink from the ejection port 302 is installed (see FIGS. 4B and 5). In the present embodiment, heating elements that utilize thermal energy to cause the ink inside the pressure chambers 508 to bubble are used as the printing elements 510. The printing elements 510 are not limited to heating elements, and various known elements capable of ejecting ink from ejection ports, such as piezoelectric elements, can be used. Further, the liquid supply paths 512 and the liquid recovery paths 514 are formed in the substrate 502 along the extending direction of the ejection port arrays, at positions corresponding to the respective ejection port arrays. Specifically, along each ejection port array, the liquid supply path 512 is formed on one side of the ejection port array in the X direction, and the liquid recovery path 514 is formed on the other side of the ejection port array in the X direction.

The liquid supply path 512 is connected to the pressure chambers 508 formed by the ejection port forming member 504 on one plane of the substrate 502 via the supply ports 516, and the liquid recovery path 514 is connected to the pressure chambers 508 on one plane of the substrate 502 via the recovery ports 518. The liquid supply path 512 and the liquid recovery path 514 communicate with the openings 420 in the state where the cover plate 506 is bonded to the substrate 502. In the present embodiment, the liquid supply path 512 communicates with the openings 420 of the opening arrays Oo, which are odd-numbered arrays with respect to the Y direction of the cover plate 506, and the liquid recovery path 514 communicates with the openings 420 of the opening arrays Oe, which are even-numbered arrays. Therefore, four openings 420 communicate with each liquid supply path 512, and three openings 420 communicate with each liquid recovery path 514. Note that the number of openings 420 communicating with the liquid supply path 512 and the number of openings 420 communicating with the liquid recovery path 514 are not limited to the above-mentioned numbers, and may be more or less than the above-mentioned numbers.

The liquid supply path 512 is connected to a common supply flow path (not illustrated in the drawings), and the liquid recovery path 514 is connected to a common recovery flow path (not illustrated in the drawings), so that a pressure difference occurs between the liquid supply path 512 and the liquid recovery path 514. Therefore, in each ejection port 302 that does not eject ink while printing is being performed by ejecting ink, this pressure difference causes ink to flow from the liquid supply path 512 to the liquid recovery path 514 through the supply port 516, the pressure chamber 508, and the recovery port 518 (see the arrows in FIG. 5).

This flow of ink allows thickened ink, bubbles, foreign matters, and the like in the ejection ports 302 that are not ejecting ink as well as in the corresponding pressure chambers 508 to be collected into the liquid recovery paths 514. Further, it is possible to suppress the ink from thickening in the ejection ports 302 and the pressure chambers 508, and suppress the concentration of the coloring materials from increasing. The ink transferred to the liquid recovery paths 514 joins together in the common recovery path and is collected into a buffer tank (not illustrated in the drawings). Further, ink pumped up from the buffer tank by a pump (not illustrated in the drawings) is supplied to the liquid supply paths 512 via the common supply path. In this way, an ink circulation system is formed in the printing apparatus 10. In the present embodiment, a heat exchanger (not illustrated in the drawings) is installed in the common supply flow path, so that the ink transferred to the liquid supply paths 512 is controlled to 25° C.

The printing elements 510 utilize thermal energy to cause ink to bubble, and the resulting bubble pressure causes the ink in the pressure chambers 508 to be ejected from the corresponding ejection ports 302. Specifically, the printing elements 510 are electrically connected to the terminals 520 installed near the end of the substrate 502 by electrical wiring (not illustrated in the drawings) installed on the printing element substrate 304. Further, the printing elements 510 generate heat based on pulse signals input from the head control part 220 to boil the ink, and the pressure of the bubbles generated by this boiling causes the ink in the pressure chambers 508 to be ejected from the ejection ports 302.

### <Temperature Adjustment Control on the Printing Element Substrate>

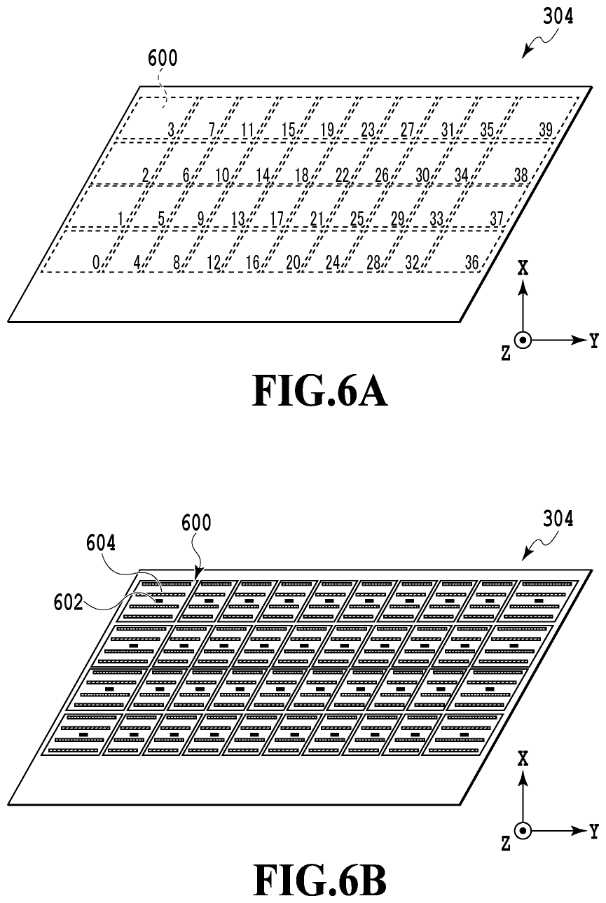

Next, a description is given about temperature control in the printing element substrates 304. FIG. 6A and FIG. 6B are diagrams illustrating the configuration for temperature control in the printing element substrate 304, where FIG. 6A illustrates the temperature control areas on the printing element substrate 304, and FIG. 6B illustrates the temperature sensors and sub-heaters installed in the respective temperature control areas. Note that the numbers illustrated in the temperature control areas in FIG. 6A are serial numbers assigned to the respective temperature control areas, which are described later.

The printing element substrate 304 has a plurality of temperature control areas 600, each of which is capable of individually executing temperature control, as illustrated in FIG. 6A. In the present embodiment, 40 temperature control areas 600 are formed. Each temperature control area 600 has the temperature sensor 602 and the sub-heaters 604 (see FIG. 6B). In the printing apparatus 10, the control part 200 uses the temperature sensors 602 and the sub-heaters 604 to perform temperature control for each temperature control area, based on the temperatures that are set for the respective temperature control areas. Specifically, the control part 200 drives the sub-heaters 604 for each temperature control area 600 whose temperature detected by the temperature sensor 602 is equal to or lower than the set target temperature. The driving energy of the sub-heaters 604 is adjusted according to the difference between the output value of the temperature sensor 602 and the target temperature. This allows for more accurate adjustment to the target temperatures. In this way, in the present embodiment, the temperature sensors 602 and the sub-heaters 604 function as a temperature adjustment part that executes temperature control for the temperature control areas 600 (the printing element substrate 304) based on target temperatures. This temperature adjustment part may be configured to include the control part 200.

As the temperature sensors 602, for example, diode sensors or aluminum sensors may be used. Alternatively, it is also possible to use the printing elements 510 to heat the printing element substrate 304 without installing the sub-heaters 604 for heating the printing element substrate 304. In this case, the printing element substrate 304 is heated by applying a voltage that is not strong enough to cause bubbles to the printing elements 510. Note that the printing apparatus 10 may be configured to use both the sub-heaters 604 and the printing elements 510 to heat the printing element substrates 304.

The main purpose of the temperature adjustment control is to keep the amount of ink ejected from each printing element 510 constant. It is known that the ink ejection amount varies depending on the temperature of the printing element substrate 304 at the time the ink is ejected. This is because the viscosity of the ink changes depending on the temperature of the printing element substrate 304, resulting in a change in the size of the bubbles formed upon boiling of the ink on the printing elements 510. If the temperature of the printing element substrate 304 rises by 1° C., the ejection amount increases by approximately 1%. That is, variation in temperature on the printing element substrate 304 result in variation in ejection amount, which causes a decrease in the printing quality as uneven density of images on the print medium M. Further, another purpose of the temperature adjustment control is to maintain the temperature of the printing element substrate 304 at a certain level or higher. The printing element substrate 304 has a predetermined lower limit value defined as the temperature at which ejection operation and ink circulation can be performed favorably, and the target temperatures of the printing element substrate 304 are set to be equal to or higher than the lower limit value. In the present embodiment, the lower limit value is set to 38.0° C., and this is set as the lower limit value of the target temperatures.

By performing temperature adjustment control, temperature variation in the printing element substrate 304 and temperature variation between multiple printing element substrates 304 can be suppressed within a predetermined range, thereby reducing the variation in ejection amount caused by these temperature variations. Further, by reducing the variation in ejection amount, it is possible to suppress uneven density in printed images. Note that the “temperature variation in the printing element substrate 304 (temperature variation)” refers to the temperature variation occurring on the XY plane of the printing element substrate 304.

The temperature variation in the printing element substrate 304 occurs because the temperature rise characteristics and heat dissipation characteristics differ for each temperature control area 600 of the printing element substrate 304, and the higher the printing duty, the greater the temperature variation tends to be. Further, the temperature variation in the printing element substrate 304 becomes even more pronounced in a configuration where ink is constantly flowing in the printing element substrate 304 due to ink circulation.

Therefore, in order to suppress variation in temperature of the printing element substrate 304 during printing operation, the temperature of each temperature control area 600 is adjusted as described below. Specifically, the target temperature of the entire printing element substrate 304 is periodically updated (set again) in accordance with the outputs of the temperature sensors 602 in the respective temperature control areas 600 of the printing element substrate 304 during printing operation, so that the range of temperature variation in the printing element substrate 304 is equal to or lower than a predetermined value. Note that the “range of temperature variation” indicates the spread of the temperature distribution, in other words, the difference between the maximum temperature and the minimum temperature. Hereinafter, a description is given about a method for setting the target temperature.

For setting the target temperature, first, the temperatures of the respective temperature control areas 600 on the printing element substrate 304 during printing operation are acquired. Since the temperature sensors 602 are arranged on a plane of the printing element substrate 304, it is possible to grasp the temperature distribution in the XY plane of the printing element substrate 304 during the printing operation by acquiring the temperatures of the respective temperature control areas 600. Next, the temperature that is −2.0° C. lower than the acquired maximum temperature among the temperature control areas 600 is acquired, and the target temperature of the printing element substrate 304 is updated to the acquired temperature. Note that, since the lower limit value is set for the target temperature, in a case where the acquired temperature is lower than the lower limit value, the target temperature is updated to the lower limit value.

As a result, the temperature control areas 600 that deviate by 2° C. or more from the maximum temperature among the temperature control areas 600 of the printing element substrate 304 (i.e., the temperature control areas 600 whose temperature is relatively low within the printing element substrate 304) are considered to be equal to or lower than the target temperature, and are selectively heated by the sub-heaters 604. On the other hand, the portions whose temperature is relatively high within the printing element substrate 304 are not heated by the sub-heaters 604 because their temperatures are higher than the target temperature that has been set again. Therefore, in the printing element substrate 304, the spread of the temperature distribution is suppressed to about 2° C. Furthermore, if the maximum temperature within the printing element substrate 304 decreases, the target temperature of the printing element substrate 304 is also set again to a decreased value accordingly. Therefore, in a case where there is no (or almost no) temperature variation in the printing element substrate 304, the lower limit value of the target temperature (38° C., in the present embodiment) is maintained.

By executing the above-described processes at intervals of 25 msec during printing operation, the target temperature is dynamically set in response to temperature change in the printing element substrate 304 caused by printing operation, and the spread of temperature distribution of the printing element substrate 304 is suppressed. For example, in a case where an image having a low duty of about 50% or less is printed, the amount of heat generated by the printing element substrate 304 is small, and the amount of supply of ink, which has a relatively low temperature (25° C., in the present embodiment), is also small. Thus, in this case, there is almost no temperature variation in the printing element substrate 304. Therefore, the target temperature of the entire printing element substrate 304 is set to 38.0° C.

On the other hand, in a case where an image having a high duty of 100% is printed, the amount of heat generated by the printing element substrate 304 is large, and the amount of supply of ink, which has a relatively low temperature, is also large. This causes temperature variation in the printing element substrate 304, and the range of the temperature variation also becomes larger. At this time, if the temperature adjustment control through the above-described processes is not executed, the maximum temperature of the printing element substrate 304 will rise to approximately 44.0° C. while the minimum temperature will be approximately 40.0° C., and thus the range of temperature variation in the printing element substrate 304 will be approximately 4° C. However, if the temperature adjustment control is executed through the above-described processes, even though the printing element substrate 304 reaches that maximum temperature, the target temperature is set to 42° C. (44° C.-2° C.), and thus the range of temperature variation in the printing element substrate 304 is suppressed to approximately 2° C.

Further, for example, in a case where an image having a duty of 100% is printed on half the area of the printing element substrate 304 and an image having a duty of 0% is printed on the other half, the range of temperature variation in the printing element substrate 304 will become even greater. However, by executing the temperature adjustment control through the above-described processes, the range of temperature variation in the printing element substrate 304 can be suppressed to approximately 2° C.

The temperature adjustment control through the above-described processes is feedback control according to output values of the temperature sensors 602 on the printing element substrate 304, and thus it is possible to obtain stable effects without being affected by variation in heat generation of the printing elements 510, variation in ink circulation flow velocity, or the like. In this way, by periodically setting the target temperature again according to the temperature state of the printing element substrate 304, it is possible to suppress temperature variation and obtain good printing quality with suppressed density unevenness in finished products.

Note that, since the printing element substrate 304 is made of Si, which has a relatively high thermal conductivity, heat can be mutually transferred between the temperature control areas 600. Assume that the target temperature is set even higher in order to reduce the range of temperature variation of the printing element substrate 304 to 2° C. or less. In this case, control may be unstable in which the maximum temperature of the printing element substrate 304 increases due to the influence of heat from adjacent temperature control areas 600, resulting in an increase in target temperature, and thus it is difficult to completely eliminate the range of temperature variation. The control parameters, etc., shown in the above description are merely examples, and are set appropriately depending on the apparatus configuration to be adopted.

### Possible Concerns Caused by Prior Art

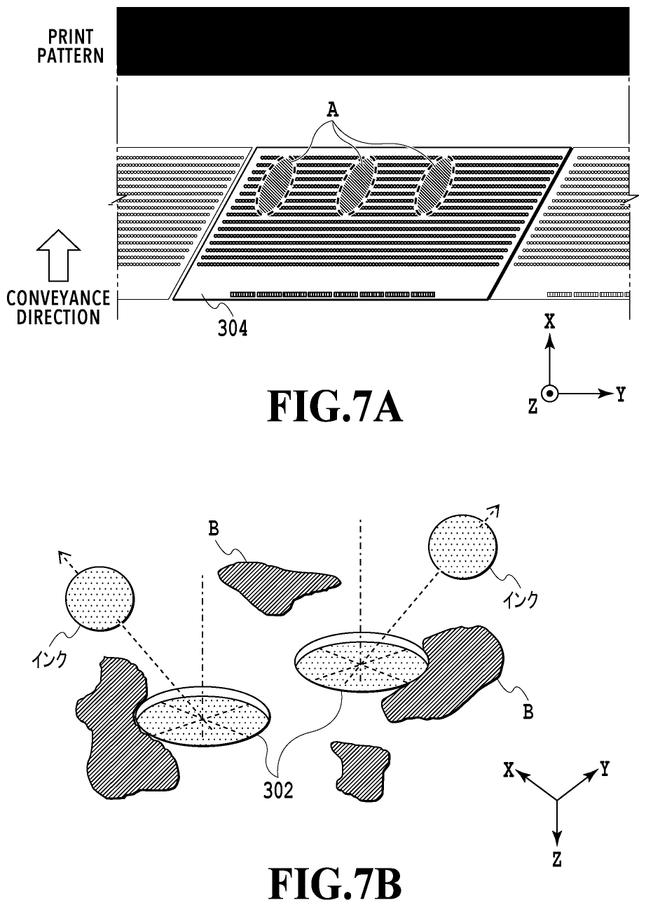

However, in known printing apparatuses, even if the temperature adjustment control described above is executed, if high-duty images are continuously printed, the printing quality gradually deteriorates. Hereinafter, a description is given about the occurrence of such a decrease in printing quality. FIG. 7A and FIG. 7B are diagrams for describing a decrease in printing quality caused by continuous printing of high-duty images. FIG. 7A is a diagram illustrating the printing element substrate 304 of interest and a print pattern formed by the printing element substrates 304 including that printing element substrate 304, and illustrates areas where condensation occurs. FIG. 7B is a diagram for describing a change in ejection performance due to condensation.

Assume that an image having a duty of 100% is allocated to the entire area of the printing element substrate 304. In the present embodiment, a duty of 100% indicates a situation in which 7 g/m² of ink is applied to the print medium M. During printing of a high-duty image, the amount of ink droplets ejected from the ejection ports 302 is large, and the amount of ink adhering to the print medium M is large. Therefore, due to the influence of the liquid component of the ink that evaporate from the ejected ink droplets and the adhering ink, the relative humidity in the space between the ejection port plane 20a and the print medium M facing the ejection port plane 20a becomes close to 100%. Furthermore, at this time, if the number of times the printing element 510 is driven is large and the temperature of the printing element substrate 304 is heated to approximately 42° C., the amount of saturated vapor in the space between the ejection port plane 20a and the print medium M increases, resulting in a state where the amount of liquid component is even larger in that space.

Since the print medium Mis conveyed in the +X direction, a conveyance airflow in the +X direction is generated in the space between the ejection port plane 20a and the print medium M. In the present embodiment, the conveyance speed of the print medium M is 0.7 m/sec. The airflow in the space between the ejection port plane 20a and the print medium M follows the Couette flow. Couette flow refers to the phenomenon in which a viscous fluid flows as a laminar flow between two parallel flat planes. This phenomenon is observed in a case where the lower flat plate moves at a constant speed and the upper flat plate is stationary. The fluid has a linear velocity distribution that varies in proportion to the velocity of the lower flat plate, and the velocity decreases in the fluid closer to the upper flat plate.

This velocity distribution can be obtained by solving the Navier-Stokes equations. Specifically, if the lower flat plate moves at a velocity U, the velocity u (y) of the fluid is expressed by the following equation.

u(y)=y×U/h

Note that y is the position between the flat plates in the vertical direction, and h is the distance between the flat plates. This linear velocity distribution is caused by the internal friction force due to the viscosity of the fluid.

According to this phenomenon, the airflow on the surface of the print medium M about 1 mm away from the ejection port plane 20a has a speed of about 0.7 m/sec in the +X direction, which is almost the same as the conveyance speed. On the other hand, the flow velocity gradually decreases as the distance from the surface of the print medium M approaches the ejection port plane 20a, and the airflow near the surface of the ejection port plane 20a is theoretically considered to have a flow velocity of 0 msec. That is, during printing operation, air with a humidity of approximately 100% continues to stagnate near the surface of the ejection port plane 20a without being moved by the conveyance airflow.

In the process where this air containing a large amount of liquid component of ink moves relatively slowly from the upstream side to the downstream side in the conveyance direction along the Couette flow over the ejection port plane 20a, the liquid component in the air is cooled and the saturated vapor pressure decreases at the time the air comes into contact with a member having a temperature lower than the temperature of the air. Accordingly, the liquid component that can no longer be retained in the air forms liquid droplets as condensation on the member in contact.

That is, the condition for condensation to occur on the ejection port plane 20a is a case in which the surface of the printing element substrates 304 on the downstream side in the conveyance direction during printing at a high duty is lower than the dew-point temperature of the air that has moved from the upstream side in the conveyance direction. Assuming that the relative humidity of the air that has moved from the upstream side in the conveyance direction is 100%, the dew-point temperature is the temperature of that air itself. Therefore, if there is temperature variation on the ejection port plane 20a, condensation will occur selectively in areas having relatively low temperatures.

If high-duty images are continuously printed by the printing apparatus 10 without taking any measures against such condensation, condensation will occur selectively in such partial areas A of the printing element substrate 304 as illustrated in FIG. 7A. Further, if printing is performed in a state where condensation has occurred on the printing element substrates 304 on the ejection port plane 20a, the printing quality of the finished products will deteriorate.

Specifically, if condensation occurs on the printing element substrates 304 arranged on the ejection port plane 20a, the droplets generated by the condensation gradually combine to form such wet areas B over a relatively broad range (see FIG. 7B). If these wet areas B come close to ejection ports 302, they affect the trajectory of the ink droplets ejected from the ejection ports 302. Specifically, the trajectories of the ink droplets may be biased toward the wet areas B, for example, and may deviate from the proper trajectories. Such changes in the trajectories of the ink droplets reduce the accuracy of positions at which the ink is applied to the print medium M, resulting in uneven density, reduced line quality, reduced character quality, and the like in the printed images.

For this reason, in the prior art, in a case where a printing apparatus continuously prints high-duty images, it is necessary to temporarily suspend printing operation and execute a cleaning process on the ejection port plane before condensation causes a decrease in printing quality. However, executing such a cleaning process significantly reduces user convenience, such as reducing productivity and causing downtime.

### Characteristic Technology of the Present Embodiment

Therefore, in the present embodiment, the target temperature of each temperature control area 600 is periodically updated (set again) in order to suppress the occurrence of condensation on the printing element substrates 304. Hereinafter, a description is given about a technology for periodically updating the target temperature of each temperature control area 600 in order to suppress the occurrence of condensation on the printing element substrates 304.

### =Mechanism of the Occurrence of Condensation=

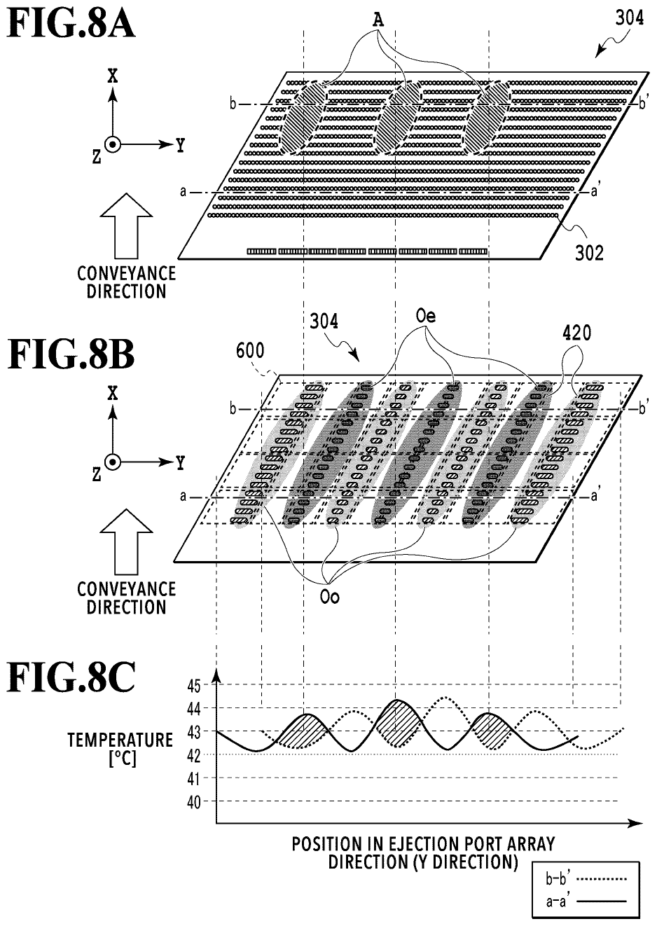

First, a description is given about the mechanism by which condensation occurs on the printing element substrates 304. FIG. 8A to FIG. 8C are diagrams for describing the mechanism by which condensation selectively occurs on the surface of the printing element substrates 304. FIG. 8A is a diagram illustrating locations where condensation occurs on the printing element substrate 304. FIG. 8B is a diagram illustrating the positional relationship between the temperature control areas 600 on the printing element substrate 304 and the openings 420 formed in the cover plate 506. FIG. 8C is a diagram illustrating the temperature change (the solid line) on line a-a′ and the temperature change (the dotted line) on line b-b′ in FIG. 8B at the time the entire printing element substrate 304 is printing an image at a duty of 100%.

The cover plate 506 is equipped with the opening arrays Oo formed by the openings 420 communicating with the liquid supply paths 512 and the opening arrays Oe formed by the openings 420 communicating with the liquid recovery paths 514 (see FIG. 8B). Since the ink supplied from each opening 420 of the opening arrays Oo is controlled to 25° C., the temperature near the opening arrays Oo tends to become relatively low on the printing element substrate 304 whose lower limit value of the target temperature is 38° C. On the other hand, ink that is not ejected from the printing element substrate 304 is heated by the heat generated by driving the printing elements 510 and the heat from the sub-heaters 604 that are driven to suppress temperature variation, and gathers at the openings 420 of the opening arrays Oe. Therefore, the temperature near the opening arrays Oe on the printing element substrate 304 tends to become relatively high. That is, in the printing element substrate 304 that has a configuration in which ink is circulated, a temperature distribution is likely to occur on its surface.

Here, the target temperature of the printing element substrate 304 is set to 42.0° C. This is a value adjusted in accordance with the outputs of the temperature sensors 602 on the printing element substrate 304. Even if the target temperature is increased to 42.0° C. or higher, the temperature distribution does not improve (i.e., the range of temperature variation does not reduce) and the maximum temperature increases, and thus 42.0° C. is considered to be the optimal target temperature for the printing element substrates 304.

In the temperature distributions on line a-a′ located on the upstream side in the conveyance direction and line b-b′ located on the downstream side in the conveyance direction, they both have temperatures change at the positions corresponding to the opening arrays Oo and opening arrays Oe (see FIG. 8C). Specifically, the temperature change on the respective lines are due to the circulation of ink, resulting in temperature differences of approximately ±1° C., and there are temperature drops near the openings 420 of the opening arrays Oo and there are temperature rises near the openings 420 of the opening arrays Oe.

Here, the areas A on the printing element substrate 304 where condensation has occurred are associated with the positions of the openings 420 in the cover plate 506 (see FIG. 8A and FIG. 8B). Then, the areas A are located near the openings 420 of the opening arrays Oo, which have relatively low temperatures, and the vicinities of the openings 420 of the opening arrays Oe, which have relatively high temperatures, are located on the upstream side of the areas A in the conveyance direction.

From this, it is considered that condensation selectively occurs in a portion of the printing element substrates 304 where the temperature on the downstream side in the conveyance direction is lower than the temperature on its upstream side. In other words, it is considered that the possibility of condensation occurring increases in an area on the downstream side in the conveyance direction, where the temperature on its upstream side in the conveyance direction is relatively high. Therefore, during printing operation, the air heated near the openings 420 of the opening arrays Oe moves to the downstream side in the conveyance direction as the print medium Mis conveyed. Further, at the time the air passes through a portion having a relatively low temperature near the openings 420 of the opening arrays Oo, condensation occurs on the surface of the printing element substrate 304 corresponding to that portion.

Note that the humidity in the space between the ejection port plane 20a and the print medium M during continuous printing varies depending on the distance between the ejection port plane 20a and the print medium M, the airflow around the print heads 20, etc. Therefore, even if the humidity in the space described above is approximately 100% and the temperature on the downstream side in the conveyance direction can be lower than that on its upstream side, condensation does not necessarily occur. This is because the humidity in the space described above may become lower than 100%, resulting in a decrease in dew-point temperature.

### Outline of the Characteristic Technology According to the Present Embodiment

Therefore, in the present embodiment, the difference between the temperature of the downstream side in the conveyance direction and the temperature of the upstream side in the conveyance direction on the printing element substrates 304 is suppressed to a value that does not cause condensation. Specifically, a target temperature higher than the target temperature of the printing element substrate 304 is set for the temperature control areas 600 on the downstream side in the conveyance direction whose temperatures are relatively low, thereby preventing the air flowing over the surface of the printing element substrate 304 from falling below the dew-point temperature.

Note that, as described above, each printing element substrate 304 is divided into 40 temperature control areas 600, each of which can individually execute temperature control. For this reason, it is possible to set a target temperature for each temperature control area, but in the present embodiment, a target temperature is set for the entire printing element substrate, and, based on that target temperature and the offset temperatures of the target temperature that are set for the temperature control areas, the target temperatures of the respective temperature control areas are updated.

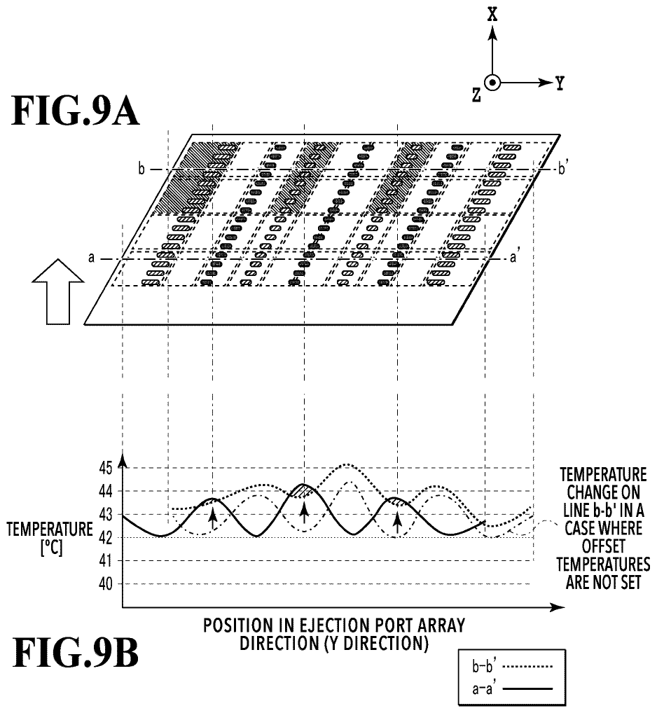

FIG. 9A and FIG. 9B are diagrams for describing an outline of the technology for suppressing condensation according to the present embodiment. FIG. 9A is a diagram illustrating temperature control areas in which offset temperatures are set, and FIG. 9B is a diagram illustrating the temperature change (the solid line) on line a-a′ in FIG. 9A and the temperature change (the dotted line) on line b-b′.

In the present embodiment, the offset temperature value is set to “+1.5° C.” for the temperature control areas 600 (see the hatched portions in FIG. 9A) including the openings 420 of the opening arrays Oo in the areas A where condensation occurs. Further, no offset temperature is set for the other temperature control areas 600, that is, “0° C.” is set. Note that the target temperature of the printing element substrate 304 is set to 42.0° C.

By executing temperature control for each temperature control area 600 based on the target temperatures updated according to such settings, the temperature rises in the portions corresponding to the temperature control areas 600 where the offset temperature is set (see the dotted line and the one-dot chain line in FIG. 9B). This reduces the difference in temperature between the areas A where condensation has occurred and the area on the upstream side of the areas A in the conveyance direction (see the arrowed portions in FIG. 9B). Therefore, it is possible to suppress the air flowing from the upstream side of the areas A in the conveyance direction from falling below the dew-point temperature in the areas A, thereby making condensation less likely to occur.

By suppressing the occurrence of condensation in this way, even if high-duty images are printed continuously for three hours, the printing quality does not deteriorate. Note that, in a case where the update of the target temperatures according to the present embodiment is not executed, the printing quality will deteriorate after about one hour of continuous printing of high-duty images, and thus it has been necessary to execute a cleaning process each time. Note that, by updating the target temperature of the temperature control areas 600 corresponding to the areas A where condensation occurs using the offset temperature, the maximum temperature of the printing element substrate 304 increases by about 0.6° C. However, by setting a necessary offset temperature at a necessary location, it is possible to minimize the temperature rise of the entire printing element substrate 304 while condensation is suppressed reliably.

The temperature control areas 600 for which an offset temperature is set and a value of the offset temperature are set to appropriate values depending on the configuration of the printing element substrates 304, the configuration of the ink circulation paths in the printing element substrates 304, and the like. Note that the offset temperature is not limited to a positive value, but may be set to a negative value. In this case, an offset temperature that is a negative value is set for the temperature control areas 600 including the openings 420 of the opening arrays Oe, which are located on the upstream side in the conveyance direction of the areas A where condensation occurs. In the present embodiment, the offset temperature is set for at least one of the temperature control areas that overlap in the conveyance direction, where the temperature of the temperature control area located on the downstream side in the conveyance direction can be lower by a predetermined value or more than the temperature of the temperature control area located on the upstream side in the conveyance direction. The predetermined value is set to, for example, 2.0° C.

In the present embodiment, an offset temperature of a predetermined value is set for specific temperature control areas in accordance with the temperature distribution that occurs due to the configuration of the circulation paths for the ink flowing through the printing element substrates 304; however, there is no such limitation. For example, a temperature distribution may occur in the printing element substrates 304 depending on the presence or absence of an adhesive agent used to fix the printing element substrates 304, the material of a support member that supports the printing element substrates 304, etc. Therefore, it is also possible that an offset temperature of a predetermined value is set for specific temperature control areas in accordance with the temperature distribution caused by the presence or absence of such an adhesive agent or the temperature distribution caused by the material of such a support member.

### =Update Process=

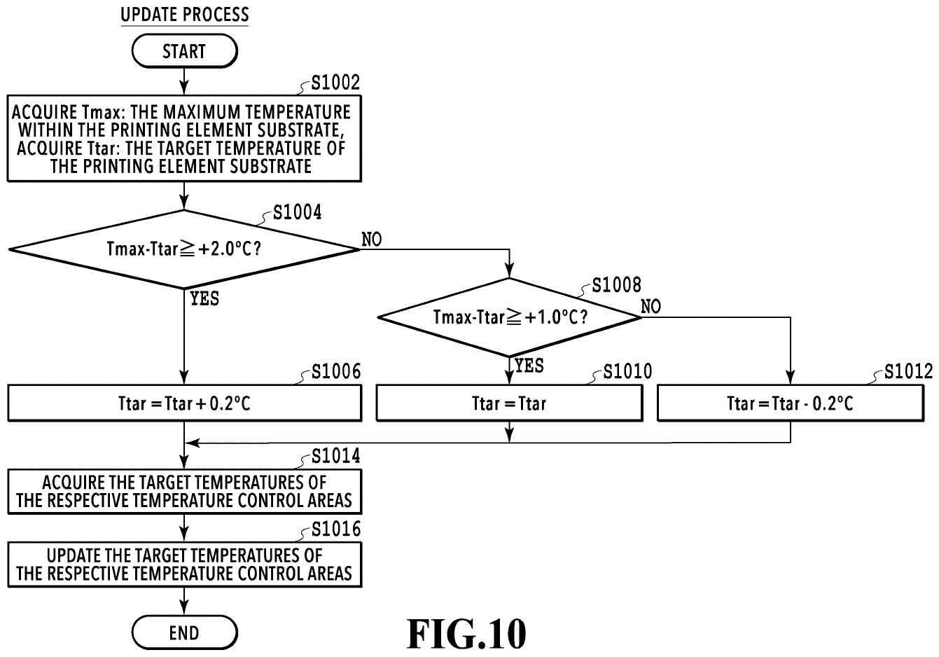

Next, a description is given about the update process for updating the target temperatures of the respective temperature control areas 600. FIG. 10 is a flowchart illustrating the details of processing of the update process for updating the target temperatures of the respective temperature control areas 600. Note that the update process in FIG. 10 is executed at intervals of a predetermined time, e.g., at intervals of 25 msec, during printing operation. Further, each print head 20 is equipped with a plurality of printing element substrates 304. Therefore, the update process of FIG. 10 is to be executed for each of the printing element substrates 304.

The series of these processes illustrated in the flowchart of FIG. 10 is performed by the CPU 212 loading a program code stored in the ROM 214 into the RAM 216 and executing it. Alternatively, part or all of the functions in the steps of FIG. 10 may be executed by hardware such as an ASIC or an electronic circuit. In the present specification, the sign “S” in the description of each process in a flowchart indicates that it is a step in the flowchart.

If the update process is started, first, in S1002, the CPU 212 acquires the maximum temperature Tmax within the target printing element substrate 304 and the target temperature Ttar of the printing element substrate 304. In S1002, the highest temperature among the temperatures detected in the 40 temperature control areas 600 of the target printing element substrate 304 is acquired as the maximum temperature Tmax. Further, the target temperature Ttar of the printing element substrate 304, which is stored in a storage area of the control part 200 such as the ROM 214 or the RAM 216 at the point in time where this process is executed, is acquired.

Next, in S1004, the CPU 212 determines whether or not the value obtained by subtracting the target temperature Ttar from the maximum temperature Tmax is equal to or higher than a predetermined value, i.e., +2.0° C. If it is determined in S1004 that the value obtained by subtracting the target temperature Ttar from the maximum temperature Tmax is equal to or higher than +2.0° C., the process proceeds to S1006. In S1006, the CPU 212 updates the target temperature Ttar of the printing element substrate 304 stored in the memory area of the control part 200 to a value obtained by adding 0.2° C. to the target temperature Ttar acquired in S1002, and proceeds to S1014, which is described later.

Further, if it is determined in S1004 that the value obtained by subtracting the target temperature Ttar from the maximum temperature Tmax is less than +2.0° C., the process proceeds to S1008. In S1008, the CPU 212 determines whether or not the value obtained by subtracting the target temperature Ttar from the maximum temperature Tmax is equal to or higher than +1.0° C. (half the value of the predetermined value). If it is determined in S1008 that the value obtained by subtracting the target temperature Ttar from the maximum temperature Tmax is equal to or higher than +1.0° C., the process proceeds to S1010. In S1010, the CPU 212 updates the target temperature Ttar of the printing element substrate 304, which is stored in the storage area of the control part 200, to the target temperature Ttar acquired in S1002, and proceeds to S1014, which is described later. That is, in S1010, the target temperature Ttar stored in the storage area of the control part 200 is maintained at the value before the update, and is not substantially updated.

Further, if it is determined in S1008 that the value obtained by subtracting the target temperature Ttar from the maximum temperature Tmax is less than +1.0° C., the process proceeds to S1012. In S1012, the CPU 212 updates the target temperature Ttar of the printing element substrate 304, which is stored in the memory area of the control part 200, to a value obtained by subtracting 0.2° C. from the target temperature Ttar acquired in S1002, and proceeds to S1014, which is described later. In this way, in the present embodiment, the CPU 212 functions as an update part that updates a target temperature that is set for temperature control.

In S1014, the CPU 212 acquires the target temperatures of the respective temperature control areas 600, based on the updated target temperature Ttar of the printing element substrate 304 and the offset temperatures that are set for the respective temperature control areas 600. In S1014, the offset temperatures for the respective temperature control areas 600 stored in the memory area of the control part 200 at the point in time where this process is executed is added to the target temperature Ttar of the printing element substrate 304 stored in the memory area, thereby acquiring the target temperatures of the respective temperature control areas 600.

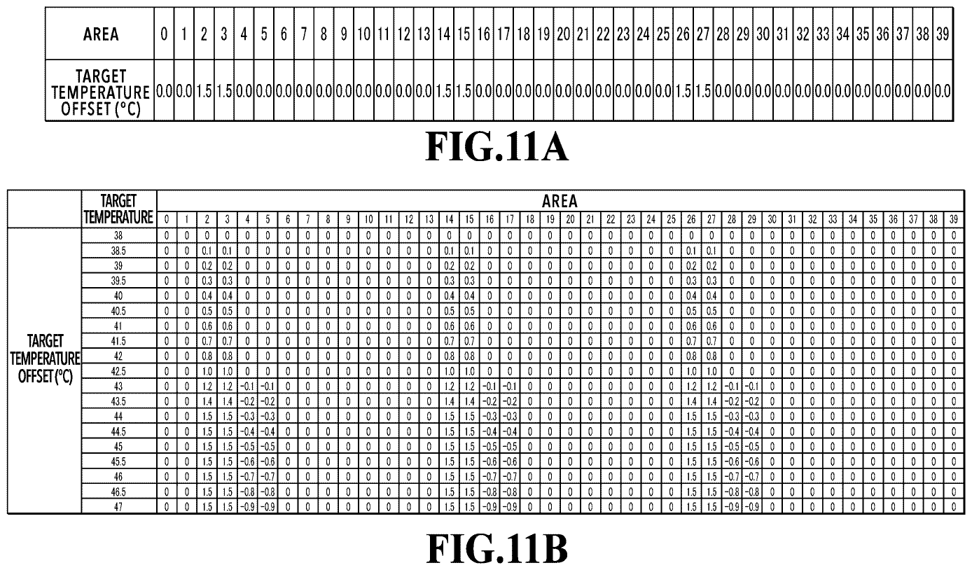

FIG. 11A and FIG. 11B are examples of a table stored in the memory area of the control part 200, in which the offset temperatures for the respective temperature control areas 600 are shown. FIG. 11A is a table illustrating the offset temperatures associated with the serial numbers from “0” to “39” assigned to the 40 temperature control areas 600 of the printing element substrate 304. FIG. 11B is a table in which the offset temperatures associated with the serial numbers assigned to the respective temperature control areas 600 change according to the target temperatures of the printing element substrate 304. In the present embodiment, the table of FIG. 11A or the table of FIG. 11B is stored in the ROM 214.

The serial numbers from “0” to “39” are assigned to the 40 temperature control areas 600 on the printing element substrate 304 (see FIG. 6A). In a case where the table of FIG. 11A is stored in ROM 214, an offset temperature of +1.5° C. is set for the temperature control areas 600 numbered 2, 3, 14, 15, 26, and 27 in which the openings 420 in the opening arrays Oo within the areas A where condensation occurs are located. For the temperature control areas 600 with other numbers, no offset temperature is set, that is, 0° C. is set.

Accordingly, the target temperatures of the temperature control areas 600 numbered 2, 3, 14, 15, 26, and 27 are set higher than the target temperatures of the temperature control areas 600 with other numbers. Therefore, the temperatures of the temperature control areas 600 numbered 2, 3, 14, 15, 26, and 27, which are relatively low due to the presence of the openings 420 communicating with the liquid supply paths 512, can be increased. That is, the offset temperature is set so that the temperatures become closer to the temperature of the area on the upstream side in the conveyance direction. This reduces the temperature difference between the areas A and the area on the upstream side in the conveyance direction, preventing the air flowing from the upstream side to the downstream side in the conveyance direction from falling below the dew-point temperature, thereby preventing condensation from occurring in the areas A.

Note that the offset temperature that is set for each temperature control area 600 is not limited to a fixed value, but may be changed according to the updated target temperature Ttar of the printing element substrate 304, for example. For example, in a case where the table of FIG. 11B is stored in the ROM 214, if the target temperature Ttar of the printing element substrate 304 is 38.0° C., no offset temperature is set for any of the temperature control areas 600, that is, 0° C. is set. Further, in a case where the target temperature Ttar of the printing element substrate 304 is 38.5° C. to 42.5° C., the offset temperatures are set to 0.1° C. to 1.0° C. for the temperature control areas 600 numbered 2, 3, 14, 15, 26, and 27 (see FIG. 11B).

Furthermore, if the target temperature Ttar of the printing element substrate 304 is 43.0° C. to 47.0° C., the offset temperatures for the temperature control areas 600 numbered 2, 3, 14, 15, 26, and 27 are set to 1.2° C. to 1.5° C. Moreover, in this case, the offset temperatures for the temperature control areas 600 numbered 4, 5, 16, 17, 28, and 29, which correspond to the areas located on the upstream side of the areas A in the conveyance direction, are set to −0.1° C. to −0.9° C. (see FIG. 11B). The higher the temperature of the printing element substrate 304, the higher the risk of condensation occurring. Therefore, the target temperatures of the temperature control areas 600 corresponding to the area having relatively high temperatures, which is on the upstream side of the areas A in the conveyance direction, are set to low temperatures; in other words, the offset temperatures of the temperature control areas 600 are set to be closer to the temperature of the areas A, thereby reducing the risk of condensation occurring. As a result, the occurrence of condensation can be more reliably suppressed.

Returning to FIG. 10, the explanation is continued. If the target temperatures of the respective temperature control areas 600 are acquired in S1014, the CPU 212 sets the acquired target temperatures of the respective temperature control areas 600 as the target temperatures of the respective temperature control areas 600 in S1016, and ends this update process. The set target temperatures of the respective temperature control areas 600 are stored in the storage area of the control part 200. Thereafter, the control part 200 performs temperature control for each temperature control area 600, based on the target temperatures that are set in S1016. Note that the various parameters used in the above description are merely examples, and will be set appropriately in accordance with the configurations of the printing element substrates 304 and the print heads 20, etc.

### Functional Effect

In the present embodiment, the target temperature of a printing element substrate is updated so that the difference between the target temperature of the printing element substrate and the highest temperature among a plurality of temperature control areas in the printing element substrate does not exceed a predetermined value (2.0° C.). Then, the target temperatures of the respective temperature control areas are set based on the updated target temperature and the offset temperatures that are set for the temperature control areas.

Accordingly, in the present embodiment, a target temperature higher than the target temperature of the printing element substrate is set for the temperature control areas included in the second area on the downstream side, in which temperatures are lower than in the first area on the upstream side in the conveyance direction. Further, a target temperature lower than the target temperature of the printing element substrate is set for the temperature control areas included in the first area on the upstream side, in which temperatures are higher than in the second area on the downstream side in the conveyance direction.

Therefore, in the present embodiment, it is possible to prevent the temperature of the air flowing over the surface of the printing element substrates from falling below the dew-point temperature during printing operation. Accordingly, in the present embodiment, it is possible to suppress the occurrence of condensation on the printing element substrates 304 arranged into an array on the ejection port plane 20a of each print head 20, thereby suppressing the number of times a cleaning process is executed and suppressing a decrease in productivity and a decrease in usability.

### Second Embodiment

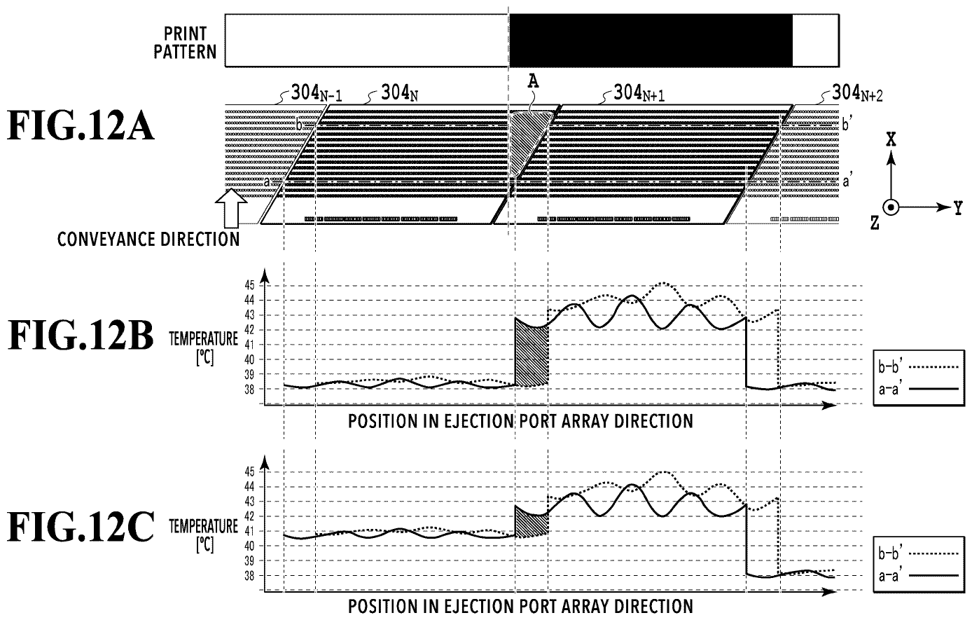

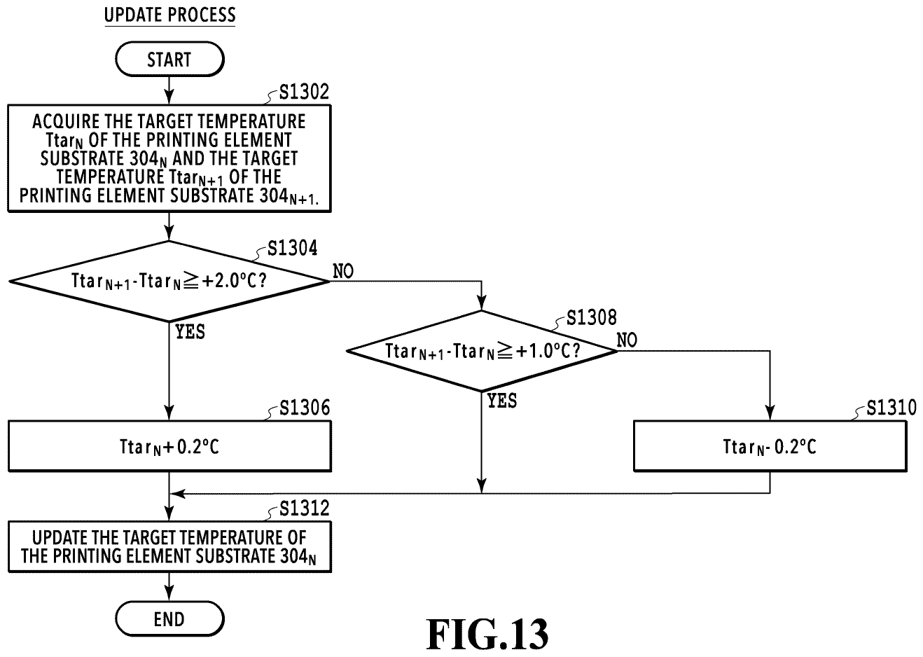

Next, with reference to FIG. 12A to FIG. 13, a description is given of a printing apparatus according to the second embodiment. In the following description, configurations that are the same or equivalent to those of the printing apparatus according to the above-described first embodiment are assigned the same signs as those used in the above-described first embodiment, thereby omitting a detailed description thereof.

The first embodiment described above is a technology for suppressing condensation that occurs on a surface of one printing element substrate, which is caused by a temperature difference that occurs within the printing element substrate. On the other hand, the second embodiment is a technology for suppressing condensation that occurs on the surface of a portion of a printing element substrate that overlaps with an adjacent printing element substrate in the conveyance direction, which is caused by a temperature difference that occurs between the adjacent printing element substrates.

### Characteristic Technology of the Present Embodiment

A description is given about a technology for suppressing condensation that occurs on the surface of an overlapping portion between adjacent printing element substrates in the conveyance direction. FIG. 12A to FIG. 12C are diagrams for describing an overview of the technology for suppressing condensation from occurring on the surface of an overlapping portion between adjacent printing element substrates in the conveyance direction. FIG. 12A is a diagram illustrating an area where condensation may occur due to adjacent printing element substrates, and a print pattern at the time condensation occurs. FIG. 12B is a diagram illustrating the temperature change (the solid line) on line a-a′ on the upstream side in the conveyance direction and the temperature change (the dotted line) on line b-b′ on the downstream side in the conveyance direction in FIG. 12A in a case where the technology according to the present embodiment is not applied. FIG. 12C is a diagram illustrating the temperature change (the solid line) on line a-a′ on the upstream side in the conveyance direction and the temperature change (the dotted line) on line b-b′ on the downstream side in the conveyance direction in FIG. 12A in a case where the technology according to the present embodiment is applied.

### =Mechanism of the Occurrence of Condensation=

First, with reference to FIG. 12A and FIG. 12B, a description is given of the mechanism by which condensation selectively occurs in the overlapping portions between adjacent printing element substrates in the conveyance direction.

For ease of understanding, the printing element substrate on which condensation occurs is referred to as the printing element substrate 304_{N}, and the printing element substrate that overlaps with a portion of the printing element substrate 304_{N} from the upstream side in the conveyance direction is referred to as the printing element substrate 304_{N+1}. Assume that a high-duty print pattern is input to the entire printing element substrate 304_{N+1}, and that the print pattern is input to only a part of the printing element substrate 304_{N} (see FIG. 12A). Note that, regarding the printing element substrate 304_{N+1}, it is assumed that the occurrence of condensation on the printing element substrate 304_{N+1} is suppressed, using the technology described in the first embodiment.

A part of printing element substrate 304_{N}, including the portion that overlaps with the printing element substrate 304_{N+1} in the conveyance direction, performs printing of a high-duty image, but the printing elements 510 are not driven in the other portion, and thus there is almost no temperature change (see FIG. 12B). Therefore, the target temperature of the printing element substrate 304_{N} is set to the lower limit value, i.e., 38.0° C. This is because the heat generated from some of the printing elements 510 that are driven diffuses immediately.

As described above, the printing element substrate 304_{N+1} and the printing element substrate 304_{N} partially overlap in the conveyance direction. Further, at this overlapping portion, the printing element substrate 304_{N+1} which performs printing of a high-duty image over the entire area is located on the upstream side in the conveyance direction, and the printing element substrate 304_{N} which performs printing of a high-duty image in a partial area is located on the downstream side in the conveyance direction. Therefore, in the portion where the printing element substrate 304_{N} and the printing element substrate 304_{N+1} overlap, the upstream side in the conveyance direction has a relatively higher temperature than the downstream side in the conveyance direction.

Therefore, condensation occurs in the area A of the printing element substrate 304_{N}, which includes the portion overlapping with the printing element substrate 304_{N+1} in the conveyance direction. Specifically, the temperature is 38.0° C. in the area A of the printing element substrate 304_{N} (see the dotted line in FIG. 12B), and 42.0° C. in the area on the upstream side of the area A in the conveyance direction (see the solid line in FIG. 12B). In this way, the temperature difference between the area A and the area on its upstream side in the conveyance direction is about 4° C., making it very likely that condensation occurs.

Note that, in the overlapping portion between the printing element substrate 304_{N+1} and the printing element substrate 304_{N+2} located to the right of it, there is a temperature difference of about 4° C. between the area on the upstream side in the conveyance direction and the area on the downstream side in the conveyance direction. However, in this overlapping portion, the area on the upstream side in the conveyance direction has a relatively lower temperature than the area on the downstream side in the conveyance direction, making it unlikely that condensation occurs.

### Outline of the Characteristic Technology According to the Present Embodiment

Therefore, in the present embodiment, in a case where the temperature of an area located on the downstream side within an overlapping portion in the conveyance direction is lower than the temperature of an area located on the upstream side within the overlapping portion in the conveyance direction, the temperatures of these two areas are set so that they have a temperature difference that does not cause condensation. Specifically, in the overlapping portion, the target temperature of the printing element substrate 304_{N}, which includes the area having a relatively low temperature, is set higher, thereby suppressing the air flowing over the surfaces of the printing element substrates 304 from falling below the dew-point temperature.

In the present embodiment, the target temperature of the printing element substrate 304_{N} is updated (set again) in accordance with the target temperature of the printing element substrate 304_{N+1}. Specifically, at the time of updating the target temperature of the printing element substrate 304_{N}, which includes the area on the downstream side within the overlapping portion in the conveyance direction, the target temperature of the printing element substrate 304_{N+1}, which includes the area on the upstream side within the overlapping portion in the conveyance direction, is monitored. Upon detecting that the target temperature of the printing element substrate 304_{N+1} exceeds the target temperature of the printing element substrate 304_{N} by a predetermined value or more, the target temperature of the printing element substrate 304_{N} is increased in accordance with the target temperature of the printing element substrate 304_{N+1}.

Accordingly, the temperature of the area on the downstream side within the overlapping portion in the conveyance direction follows the temperature of the area on the upstream side within the overlapping portion in the conveyance direction while maintaining a predetermined temperature difference (see FIG. 12C), thereby suppressing the occurrence of condensation. However, if the temperature of the area on the downstream side in the conveyance direction is raised indiscriminately, the occurrence of condensation can be suppressed, but it may also promote the evaporation of the liquid component from the ejection ports 302 located in that area, which increases the possibility of ejection failure. Therefore, the temperature of the area on the downstream side within the overlapping portion in the conveyance direction does not need to exceed the temperature of the upstream side in the conveyance direction, and it is preferable that the temperature difference between the two areas does not cause the air flowing over the surfaces of the printing element substrates to fall below the dew-point temperature, and that the temperatures of the two areas are set as lower as possible. Further, if the target temperature of the printing element substrate 304_{N+1} is lowered, the target temperature of the printing element substrate 304_{N} is also lowered accordingly.

Note that, in the present embodiment, the target temperature of the printing element substrate 304_{N} is updated in accordance with the target temperature of the printing element substrate 304_{N} and the target temperature of the printing element substrate 304_{N+1}; however, there is no such limitation. For example, the target temperature of the printing element substrate 304_{N} may be updated in accordance with a local temperature of the printing element substrate 304_{N+1} in the area on the upstream side within the overlapping portion in the conveyance direction. Alternatively, the target temperature of the printing element substrate 304_{N} may be updated in accordance with the average temperature of the temperature control areas 600 in the printing element substrate 304_{N+1} corresponding to the area on the upstream side within the overlapping portion in the conveyance direction. Note that, in the overlapping portion, the target temperature of the printing element substrate 304_{N} may be set in any way as long as the air flowing over the surface of the printing element substrates 304 from the upstream side in the conveyance direction does not fall below the dew-point temperature on the downstream side in the conveyance direction.

### =Update Process=

Next, a description is given about an update process in which the target temperature of a printing element substrate including an area on the downstream side within an overlapping portion in the conveyance direction is updated in accordance with the target temperature of a printing element substrate including an area on the upstream side within the overlapping portion in the conveyance direction. FIG. 13 is a flowchart illustrating the details of processing of the update process in which the target temperature of a printing element substrate including an area on the downstream side within an overlapping portion in the conveyance direction is updated in accordance with the target temperature of a printing element substrate including an area on the upstream side within the overlapping portion in the conveyance direction.

Note that the update process in FIG. 13 is executed at intervals of a predetermined time, e.g., at intervals of 25 msec, during printing operation. Further, each print head 20 is equipped with a plurality of printing element substrates 304. Therefore, the update process in FIG. 13 is executed for each printing element substrate 304 that overlaps with its adjacent printing element substrate 304 and includes therein an area on the downstream side within the overlapping portion in the conveyance direction.

The series of these processes illustrated in the flowchart of FIG. 13 is performed by the CPU 212 loading a program code stored in the ROM 214 into the RAM 216 and executing it. Alternatively, part or all of the functions in the steps of FIG. 13 may be executed by hardware such as an ASIC or an electronic circuit.

If the update process is started, first, in S1302, the CPU 212 acquires the target temperature Ttar_{N} of the target printing element substrate 304_{N} and the target temperature Ttar_{N+1} of the adjacent printing element substrate 304_{N+1}. Note that the printing element substrate 304_{N+1} is a printing element substrate that overlaps with the printing element substrate 304_{N} and includes the area on the upstream side within the overlapping portion in the conveyance direction. The target temperatures of the respective printing element substrates 304 are stored in a memory area of the control part 200, and thus in S1302, the target temperatures of the printing element substrates 304_{N} and 304_{N+1} stored in the control part 200 are acquired.

Next, in S1304, the CPU 212 determines whether or not the value obtained by subtracting the target temperature Ttar_{N} from the target temperature Ttar_{N+1} is +2.0° C. or more. If it is determined in S1304 that the value obtained by subtracting the target temperature Ttar_{N} from the target temperature Ttar_{N+1} is +2.0° C. or more, the process proceeds to S1306. In S1306, the CPU 212 adds 0.2° C. to the target temperature Ttar_{N} acquired in S1302, and proceeds to S1312, which is described later.

Further, if it is determined in S1304 that the value obtained by subtracting the target temperature Ttar_{N} from the target temperature Ttar_{N+1} is less than +2.0° C., the process proceeds to S1308. In S1308, the CPU 212 determines whether or not the value obtained by subtracting the target temperature Ttar from the target temperature Ttar_{N+1} is +1.0° C. or more. If it is determined in S1308 that the value obtained by subtracting the target temperature Ttar_{N} from the target temperature Ttar_{N+1} is +1.0° C. or more, the process proceeds to S1312, which is described later.

Further, if it is determined in S1308 that the value obtained by subtracting the target temperature Ttar_{N} from the target temperature Ttar_{N+1} is less than +1.0° C., the process proceeds to S1310 In S1310, the CPU 212 subtracts 0.2° C. from the target temperature Ttar_{N} acquired in S1302, and proceeds to S1312, which is described later.

In S1312, the CPU 212 updates the target temperature Ttar of the printing element substrate 304_{N} stored in the storage area of the control part 200, and ends this update process. Specifically, if S1312 is executed via S1306, in S1312, the target temperature Ttar_{N} of the printing element substrate 304_{N} stored in the control part 200 is updated to the value acquired in S1306. Further, if S1312 is executed after it is determined in S1308 that the value obtained by subtracting the target temperature Ttar_{N} from the target temperature Ttar_{N+1} is +1.0° C. or more, in S1312, the target temperature Ttar_{N} of the printing element substrate 304_{N} stored in the control part 200 is maintained. That is, the target temperature is updated to Ttar_{N} acquired in S1302. That is, in this case, no update is actually performed. Furthermore, if S1312 is executed via S1310, in S1312, the target temperature Ttar_{N} of the printing element substrate 304_{N} stored in the control part 200 is updated to the value acquired in S1310.

Thereafter, the control part 200 performs temperature control for the printing element substrate 304_{N}, based on the target temperature updated in S1312. Note that the various parameters used in the above descriptions are merely examples, and will be set appropriately in accordance with the configuration of the printing element substrates 304, the configuration of the print heads 20, the arrangement of the printing element substrates 304, etc.

The printing apparatus 10 is not limited to executing only the update process of FIG. 13, but may also execute the update process of FIG. 10 in parallel. In this case, in the update process of FIG. 10 for the printing element substrate 304_{N}, for example, in S1002, the target temperature updated in the update process of FIG. 13 is acquired as the target temperature of the printing element substrate 304.

In the present embodiment, a print head in which parallelogram-shaped printing element substrates are arranged into an array in a direction intersecting with the conveyance direction so that they have overlapping areas in the conveyance direction is described as an example, but the shape of the printing element substrates and the arrangement thereof are not limited to this. The technology according to the present embodiment can be applied to printing element substrates of any shape and can be applied to printing element substrates of any arrangement as long as the printing element substrates have overlapping areas in the conveyance direction. Specifically, the technology according to the present embodiment can also be used for, for example, rectangular printing element substrates that are arranged into an array in staggered arrangement extending in the width direction (the Y direction) of the print medium and that are arranged so that adjacent printing element substrates partially overlap in the array direction.

### Functional Effect

In the present embodiment, for a printing element substrate that overlaps with an adjacent printing element substrate and includes an area on the downstream side within the overlapping portion in the conveyance direction, the target temperature is determined so that the difference from the target temperature of the adjacent printing element substrate does not exceed a predetermined value (2.0° C.). Therefore, in the present embodiment, it is possible to prevent the temperature of the air flowing over the surface of the printing element substrates from falling below the dew-point temperature during printing operation. Accordingly, in the present embodiment, it is possible to suppress the occurrence of condensation on the printing element substrates 304 arranged into an array on the ejection port plane 20a of each print head 20, thereby suppressing the number of times a cleaning process is executed and suppressing a decrease in productivity and a decrease in usability.

### Third Embodiment

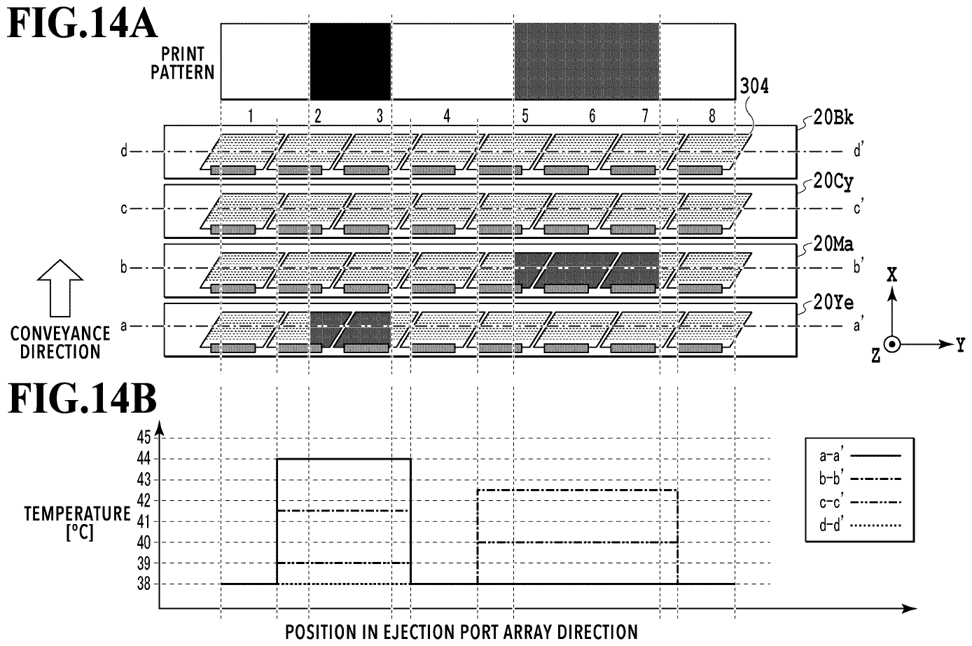

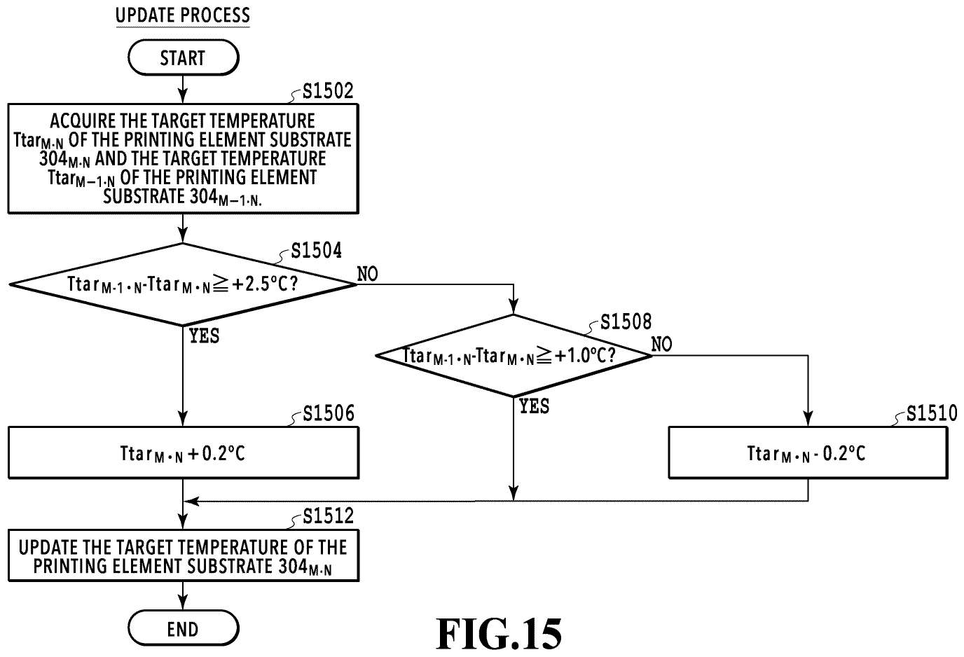

Next, with reference to FIG. 14A to FIG. 15, a description is given about a printing apparatus according to the third embodiment. In the following description, configurations that are the same or equivalent to those of the printing apparatus according to the above-described first embodiment are assigned the same signs as those used in the above-described first embodiment, thereby omitting a detailed description thereof.

The second embodiment described above is a technology for suppressing the occurrence of condensation on printing element substrates arranged adjacent to each other into an array in the width direction of the print medium M while overlapping with each other in the conveyance direction in one print head. On the other hand, the third embodiment is a technology for suppressing the occurrence of condensation on a printing element substrate that overlaps in the conveyance direction with a printing element substrate installed on another print head.

### Characteristic Technology of the Present Embodiment

Hereinafter, a description is given about a technology for suppressing condensation that occurs on a printing element substrate that overlaps in the conveyance direction with a printing element substrate installed on an adjacent print head.

### =Mechanism of the Occurrence of Condensation=

First, a description is given of the mechanism by which condensation occurs on a printing element substrate that overlaps in the conveyance direction with a printing element substrate installed on an adjacent print head. FIG. 14A and FIG. 14B are diagrams for describing the mechanism by which condensation occurs on a printing element substrate that overlaps in the conveyance direction with a printing element substrate installed on an adjacent print head. FIG. 14A is a diagram illustrating a situation in which print patterns are input to multiple print heads, i.e., a print pattern with a duty of 100% is input to the print head Ye and a print pattern with a duty of 70% is input to the print head Me. FIG. 14B is a diagram illustrating the target temperatures that are set for each printing element substrate of the respective print heads in a case where the target temperatures of the printing element substrates on the downstream side in the conveyance direction are determined according to the target temperatures of the printing element substrates located on the upstream side in the conveyance direction. Note that, in FIG. 14A, above the print head 20Bk, serial numbers 1 to 8 are given to the printing element substrates installed on each print head in order from the left.

In a case where the interval between print heads is large, the vapor generated at a position corresponding to a printing element substrate of a print head located on the upstream side in the conveyance direction is diffused to the surrounding area as it moves to the downstream side in the conveyance direction. Therefore, condensation is unlikely to occur on the printing element substrates of a print head located on the downstream side in the conveyance direction. However, in recent years, printing apparatuses have become downsized, and there is a tendency for print heads to be arranged close to each other. If print heads are close to each other, the vapor of ink ejected from printing element substrates of a print head located on the upstream side in the conveyance direction is less likely to diffuse to the surrounding area, which may cause condensation to occur on the printing element substrates of a print head located on the downstream side in the conveyance direction.

The printing elements 510 are driven due to the printing based on the print patterns of FIG. 14A, and thus the temperature of the second and third printing element substrates 304 in the print head 20Ye rise to approximately 44.0° C. (see the solid line in FIG. 14B). Further, the printing elements 510 are driven due to the printing based on the print patterns, and thus the temperature of the fifth, sixth, and seventh printing element substrates 304 in the print head 20Ma rise to an average of approximately 42.0° C. (see the one-dot chain line in FIG. 14B).

That is, in the printing based on the print patterns of FIG. 14A, the second and third printing element substrates 304 of the print head 20Ye and the fifth, sixth, and seventh printing element substrates 304 of the print head 20Ma are used. The vapor heated by the printing element substrates 304 used for the printing is carried by the conveyance airflow to the printing element substrates 304 on the other print heads located on the downstream side in the conveyance direction of the printing element substrates 304 used for the printing. If this vapor is carried by the conveyance airflow and comes into contact with any printing element substrate 304 whose temperature is lower than the dew-point temperature, condensation occurs there.

### =Outline of the Characteristic Technology According to the Present Embodiment=

Therefore, in the present embodiment, regarding a print head adjacent on the downstream side in the conveyance direction to a print head equipped with a printing element substrate used for printing, the target temperature is increased for the printing element substrate located on the downstream side in the conveyance direction of the printing element substrate used for the printing, so as to suppress the occurrence of condensation.

The vapor generated by heat from the printing element substrates 304 used for printing diffuses to the surrounding area while moving to the print head 20 on the downstream side in the conveyance direction. Therefore, by the time the vapor reaches the printing element substrates 304 on the downstream side in the conveyance direction, the dew-point temperature has dropped, and thus a temperature equal to or higher than the target temperature of the printing element substrates 304 on the upstream side in the conveyance direction is not necessarily required.

In the present embodiment, the target temperature is updated (set again) for the printing element substrates 304 which are installed on a print head 20 located on the downstream side in the conveyance direction of the print head 20 equipped with the printing element substrates 304 used for printing and are located on the downstream side in the conveyance direction of the printing element substrates 304 used for printing.

Specifically, the target temperatures of the printing element substrates 304 located on the downstream side in the conveyance direction are set so that the differences from the target temperatures of the printing element substrates 304 used for printing do not exceed a predetermined value. In the present embodiment, the predetermined value is set to, for example, 2.5° C.

Note that, depending on the arrangement pattern, shape, etc., of the print heads 20, the target temperatures may be further updated (set again) for the printing element substrates 304 which are located on the downstream side in the conveyance direction of the printing element substrates 304 used for printing and are installed on the print head 20 located on the downstream side in the conveyance direction. Further, the above-described predetermined temperature is determined, for example, through experiments in accordance with the configurations of the printing element substrates 304 and the print heads 20, the arrangement of the printing element substrates 304 and the print heads 20, etc. Specifically, images may be obtained in advance at several predetermined temperature settings, and the highest value at which no condensation occurs on the printing element substrates can be set as the predetermined temperature. By adopting such a configuration, it is possible to obtain the effect without increasing the temperatures of the printing element substrates as much as possible.

In this way, the target temperatures of the printing element substrates 304 located on the downstream side in the conveyance direction of the printing element substrates 304 used for printing are set to be higher than the dew-point temperature of the air containing the vapor generated by heat from the printing element substrates 304 used for printing. This makes it possible to suppress condensation from occurring on the printing element substrates 304 located on the downstream side in the conveyance direction, and to suppress a decrease in printing quality.

### =Update Process=

Next, a description is given about an update process for updating the target temperature of a printing element substrate which is installed on a print head located on the downstream side in the conveyance direction of the print head equipped with the printing element substrates used for printing and is located on the downstream side in the conveyance direction of the printing element substrate used for printing. FIG. 15 is a flowchart illustrating details of processing of the update process. Note that the update process in FIG. 15 is executed at intervals of a predetermined time, e.g., at intervals of 25 msec, during printing operation. Further, the update process of FIG. 15 is executed for all the printing element substrates 304 except for the printing element substrates 304 of the print head 20 located at the most upstream position in the conveyance direction.

The series of these processes illustrated in the flowchart of FIG. 15 is performed by the CPU 212 loading a program code stored in the ROM 214 into the RAM 216 and executing it. Alternatively, part or all of the functions in the steps of FIG. 15 may be executed by hardware such as an ASIC or an electronic circuit.

If the update process is started, first, in S1502, the CPU 212 acquires the target temperature Ttar_{M·N} of the target printing element substrate (the N-th printing element substrate 304_{M·N}) in the target print heat (the M-th print head 20_{M·N}). Further, the N-th printing element substrate 304_{M-1·N} in the (M−1)-th print head 20_{M-1} located on the upstream side in the conveyance direction of the print heads 20_{M·N} is acquired. In the present embodiment, for ease of understanding, it is assumed that the print heads 20 are assigned serial numbers in order from the upstream side to the downstream side in the conveyance direction. Note that the target temperatures of the respective printing element substrates 304 installed in each print head 20 are stored in a storage area of the control part 200.

Next, in S1504, the CPU 212 determines whether or not the value obtained by subtracting the target temperature Ttar_{M·N} from the target temperature Ttar_{M-1·N} is +2.5° C. or more. If it is determined in S1504 that the value obtained by subtracting the target temperature Ttar_{M·N} from the target temperature Ttar_{M-1·N} is +2.5° C. or more, the process proceeds to S1506. In S1506, the CPU 212 adds 0.2° C. to the target temperature Ttar_{M·N} acquired in S1502, and proceeds to S1512, which is described later.

Further, if it is determined in S1504 that the value obtained by subtracting the target temperature Ttar_{M·N} from the target temperature Ttar_{M-1·N} is less than +2.5° C., the process proceeds to S1508. In S1508, the CPU 212 determines whether or not the value obtained by subtracting the target temperature Ttar_{M·N} from the target temperature Ttar_{M-1·N} is +1.0° C. or more. If it is determined in S1508 that the value obtained by subtracting the target temperature Ttar_{M·N} from the target temperature Ttar_{M-1·N} is +1.0° C. or more, the process proceeds to S1512, which is described later.

Further, if it is determined in S1508 that the value obtained by subtracting the target temperature Ttar_{M·N} from the target temperature Ttar_{M-1·N} is less than +1.0° C., the process proceeds to S1510. In S1510, the CPU 212 subtracts 0.2° C. from the target temperature Ttar_{M·N} acquired in S1502, and proceeds to S1512, which is described later.

In S1512, the CPU 212 updates the target temperature Ttar_{M·N} of the printing element substrate 304_{M·N} stored in the storage area of the control part 200, and ends this update process. Specifically, if S1512 is executed via S1506, in S1512, the target temperature Ttar_{M·N} of the printing element substrate 304_{M·N} stored in the control part 200 is updated to the value acquired in S1506. Further, if S1512 is executed after it is determined in S1508 that the value obtained by subtracting the target temperature Ttar_{M·N} from the target temperature Ttar_{M-1·N} is +1.0° C. or more, the target temperature Ttar_{M·N} of the printing element substrate 304_{M·N} stored in the control part 200 is maintained. That is, the target temperature is updated to Ttar_{M·N} obtained in S1502. That is, in this case, no update is actually performed in S1512. Furthermore, if S1512 is executed via S1510, in S1512, the target temperature Ttar_{M·N} of the printing element substrate 304_{M·N} stored in the control part 200 is updated to the value acquired in S1510.

Thereafter, the control part 200 preforms temperature control for the printing element substrate 304, based on the target temperature updated in S1512. Note that the various parameters used in the above descriptions are merely examples, and will be set appropriately in accordance with the configurations of the printing element substrates 304 and the print heads 20, the arrangement of the printing element substrates 304 and the print heads 20, etc.

The printing apparatus 10 is not limited to executing only the update process of FIG. 15, but may also execute the update process of FIG. 10 in parallel. In this case, in the update process of FIG. 10 for the printing element substrate 304_{M·N}, for example, in S1002, the target temperature updated in the update process of FIG. 15 is acquired as the target temperature of the printing element substrate 304.

### Functional Effect

In the present embodiment, a target temperature of a given printing element substrate is set based on the target temperature of the printing element substrate which is installed on the upstream side in the conveyance direction of the given printing element substrate and is located in a print head on the upstream side in the conveyance direction of the print head equipped with the given printing element substrate. Accordingly, in the present embodiment, it is possible to suppress the occurrence of condensation on the printing element substrates 304 arranged into an array on the ejection port plane 20a, thereby suppressing the number of times the cleaning process is executed and suppressing a decrease in productivity and a decrease in usability.

### Fourth Embodiment

In the first to third embodiments, as examples of the occurrence of condensation on a printing element substrate, descriptions are given of the mechanisms by which condensation occurs in three situations and the technologies for suppressing the occurrence of condensation. Further, with reference to FIG. 10, a description is given also of the update process that can suppress condensation without increasing the temperatures of the printing element substrates as much as possible. On the other hand, in the present embodiment, a description is given about a configuration for suppressing the occurrence of condensation without using the update processes.

As described above, with the update process illustrated in FIG. 10, the target temperature of an entire printing element substrate is updated in accordance with the temperature rise of the printing element substrate caused by printing, thereby making it possible to keep the temperature distribution of the printing element substrate within a predetermined range at all times. However, the method for keeping the temperature distribution of printing element substrates within a predetermined range is not limited to this.

For example, assume that, in a case where images are continuously printed at a duty of 100%, the maximum temperature reached by a printing element substrate is 45° C. In this case, as a method for suppressing the temperature distribution of the printing element substrate within a predetermined value, the target temperature of the printing element substrate is set to the maximum temperature or higher at all time, such as to 46° C. As a result, even if images with high image duties are printed for a long period of time, the set target temperature will not be exceeded, and thus the temperature distribution of the printing element substrate can be kept within a predetermined value at all time. In this state, as illustrated in FIG. 11A and FIG. 11B, condensation can be suppressed by setting an offset temperature so that the temperature of an area on the downstream side in the conveyance direction has a temperature difference from the temperature of an area on the upstream side in the conveyance direction to prevent condensation from occurring. However, since the temperature is kept being controlled to a temperature equal to or higher than the maximum temperature that can be reached by the printing element substrate at all time regardless of the duty of the images to be printed, the first to third embodiments are more preferable in terms of power consumption. However, in the present embodiment, the effect of suppressing the occurrence of condensation can be obtained as in the first to third embodiments.

### OTHER EMBODIMENTS

Note that the above-described embodiments may be modified as shown in the following (1) through (4).
(1) In the above-described embodiments, the printing apparatus 10 is a line type printing apparatus that uses print heads whose length in the Y direction corresponds to the printable widthwise length of a print medium; however, there is no such limitation. The printing apparatus may be what is termed as a serial scan type printing apparatus in which print heads perform printing by ejecting ink onto the print medium while scanning in the width direction of the print medium being conveyed.

In this case, the print heads 20 reciprocally move in the Y direction, and the printing element substrates 304 in the print heads 20 are arranged side by side along the X direction so that adjacent printing element substrates 304 partially overlap in the Y direction. Further, in this case, printing is performed by ejecting ink onto the printing area of the print medium M conveyed by the conveyance part 18 while moving the print heads 20 in the X direction. Further, in this case, the actual positions of upstream and downstream sides of the temperature control areas, the printing element substrates, and the print heads change in accordance with the movement direction (the forward direction or the backward direction) of the print heads 20 in the Y direction at the time of ejecting ink. That is, in a case where the print heads perform scanning, the printing element substrates on the side toward the traveling direction is the downstream side, and the printing element substrates on the opposite side to the traveling direction is the upstream side, and they are switched between the forward direction and the backward direction.
(2) In the above-described embodiments, the print medium M is conveyed in the X direction while the print heads 20 are in fixed positions with respect to the conveyance part 18; however, there is no such limitation. For example, the print heads 20 may be configured to move in the X direction relative to the print medium M, and any configuration may be used as long as the print heads 20 and the print medium M move relatively in the X direction.
(3) Embodiment(s) of the present invention can also be realized by a computer of a system or apparatus that reads out and executes computer executable instructions (e.g., one or more programs) printed on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.
(4) The above-described embodiments and the various forms shown in (1) through (3) may be combined as appropriate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to suppress the occurrence of condensation.

This application claims the benefit of Japanese Patent Application No. 2025-007678, filed Jan. 20, 2025, which is hereby incorporated by reference herein in its entirety.

What is claimed is:

1. A printing apparatus comprising:
a printing element substrate configured to eject ink from ejection ports by driving printing elements onto a print medium that performs relative movement;
an update unit configured to update target temperatures for temperature adjustment; and
a temperature adjustment unit configured to be capable of executing temperature adjustment for a plurality of areas in the printing element substrate in accordance with the target temperatures,
wherein the plurality of areas includes a first area and a second area that partially overlaps with the first area in a first direction, which is the direction of the relative movement, and that is located on the upstream side relative to the first area,
wherein the update unit updates the target temperatures corresponding to the plurality of areas based on the target temperature corresponding to the printing element substrate and offset temperatures that are set for the plurality of areas, and
wherein the offset temperatures for the first area and the second area are set so as to make a temperature of the first area become close to a temperature of the second area.

2. The printing apparatus according to claim 1,
wherein, in a case where a difference between the target temperature corresponding to the printing element substrate and the highest temperature within the plurality of areas is a first value, the update unit updates the target temperature corresponding to the printing element substrate to a second value,
wherein, in a case where the difference is a third value that is smaller than the first value, the update unit updates the target temperature corresponding to the printing element substrate to a fourth value that is smaller than the second value, and
wherein the target temperatures corresponding to the plurality of areas are updated based on the updated target temperature corresponding to the printing element substrate and the offset temperatures.

3. The printing apparatus according to claim 1,
wherein the printing element substrate is configured such that
ink is supplied to pressure chambers in which the printing elements are installed and ink is collected from the pressure chambers, and
a first opening array and a second opening array are alternately arranged side by side along a second direction which intersects with the first direction, the first opening array including first openings arranged at an angle with respect to the first direction through which the ink supplied to the pressure chambers is supplied to the printing element substrate, the second opening array including second openings arranged at an angle with respect to the first direction through which the ink collected from the pressure chambers is collected from the printing element substrate.

4. The printing apparatus according to claim 3,
wherein the first openings are located in the first area, and
wherein the second openings are located in the second area.

5. The printing apparatus according to claim 1,
wherein the offset temperature set in the first area is a positive value.

6. The printing apparatus according to claim 1,
wherein the offset temperature set in the second area is a negative value.

7. The printing apparatus according to claim 1,
wherein the offset temperatures are fixed values provided for the plurality of areas.

8. The printing apparatus according to claim 1,
wherein the offset temperatures are values that vary depending on the target temperature corresponding to the printing element substrate.

9. The printing apparatus according to claim 1 further comprising:
a conveyance unit configured to convey the print medium in the first direction; and
a print head configured to include a plurality of the printing element substrates arranged side by side in a second direction which intersects with the first direction, and configured to be in a fixed position to perform printing by ejecting ink from the ejection ports onto the print medium conveyed by the conveyance unit.

10. The printing apparatus according to claim 1 further comprising:
a conveyance unit configured to convey the print medium in a second direction which intersects with the first direction; and
a print head configured to include a plurality of the printing element substrates arranged side by side in the second direction, and configured to perform printing by ejecting ink from the ejection ports onto a printing area of the print medium conveyed by the conveyance unit while moving in the first direction.

11. A printing apparatus comprising:
a print head configured to include a plurality of printing element substrates that are capable of ejecting ink from ejection ports by driving printing elements and are arranged into an array extending in a first direction, and configured to perform printing by ejecting ink from the ejection ports onto a print medium, which performs relative movement in a second direction which intersects with the first direction;
an update unit configured to update target temperatures for temperature adjustment; and
a temperature adjustment unit configured to be capable of executing temperature adjustment for each of the printing element substrates in accordance with the target temperatures,
wherein the plurality of printing element substrates is arranged so as to extend in the first direction such that adjacent printing element substrates partially overlap in the second direction, and
wherein, in a case where a difference between the target temperature corresponding to a first printing element substrate located on the downstream side in the second direction among the printing element substrates overlapping in the second direction and the target temperature corresponding to a second printing element substrate located on the upstream side in the second direction is a first value, the update unit updates the target temperature corresponding to the first printing element substrate to a second value, and, in a case where the difference is a third value that is greater than the first value, the update unit updates the target temperature corresponding to the first printing element substrate to a fourth value that is greater than the second value.

12. A printing apparatus comprising:
a plurality of print heads each configured to include a plurality of printing element substrates that are capable of ejecting ink from ejection ports by driving printing elements and are arranged into an array extending in a first direction, and configured to perform printing by ejecting ink from the ejection ports onto a print medium that performs relative movement in a second direction which intersects with the first direction;
an update unit configured to update target temperatures for temperature adjustment; and
a temperature adjustment unit configured to be capable of executing temperature adjustment for each of the printing element substrates in accordance with the target temperatures,
wherein, in a case where a difference between the target temperature corresponding to a first printing element substrate within a first print head located on the downstream side in the second direction among the print heads overlapping in the second direction and the target temperature corresponding to a second printing element substrate located on the upstream side in the second direction relative to the first printing element substrate within a second print head located on the upstream side in the second direction is a first value, the update unit updates the target temperature corresponding to the first printing element substrate to a second value, and, in a case where the difference is a third value that is greater than the first value, the update unit updates the target temperature corresponding to the first printing element substrate to a fourth value that is greater than the second value.

13. The printing apparatus according to claim 12,
wherein, in a case where the difference is a fifth value that is smaller than the first value, the update unit updates the target temperature corresponding to the first printing element substrate to a sixth value that is smaller than the second value.

14. The printing apparatus according to claim 11 further comprising
a conveyance unit configured to convey the print medium in the second direction,
wherein the print head is configured to be in a positioned state to perform printing by ejecting ink from the ejection ports onto the print medium conveyed in the second direction by the conveyance unit.

15. The printing apparatus according to claim 11 further comprising
a conveyance unit configured to convey the print medium in the first direction,
wherein the print head is configured to perform printing by ejecting ink from the ejection ports onto a printing area of the print medium conveyed in the first direction by the conveyance unit while moving in the second direction.

16. The printing apparatus according to claim 1,
wherein the target temperature corresponding to a given target updated by the update unit is higher than a dew-point temperature of air that is heated on the upstream side of the given target.

17. A non-transitory computer readable storage medium storing a program for causing a computer to perform a control method of a printing apparatus,
the printing apparatus comprising:
a printing element substrate configured to eject ink from ejection ports by driving printing elements onto a print medium that performs relative movement; and
a temperature adjustment unit configured to be capable of executing temperature adjustment for a plurality of areas in the printing element substrate in accordance with target temperatures,
wherein the plurality of areas includes a first area and a second area that partially overlaps with the first area in a first direction, which is the direction of the relative movement, and that is located on the upstream side relative to the first area,
the control method comprising:
a first step for updating the target temperatures corresponding to the plurality of areas based on the target temperature corresponding to the printing element substrate and offset temperatures that are set for the plurality of areas,
wherein the offset temperatures for the first area and the second area are set so as to make a temperature of the first area become close to a temperature of the second area.
